(19) United States
(12) Patent Application Publication
(10) Pub. No.: US 2011/0041473 A1
(43) Pub. Date: Feb. 24, 2011

(54) Apparatus And Method For In Situ Gas-Phase Preparation And Predetermined Deflagration Of Nitrocellulose

(76) Inventor: Joshua Waldhorn, Kfar Shmariyahu (IL)

Correspondence Address: The Law Office of Michael E. Kondoudis, 888 16th Street, N.W., Suite 800, Washington, DC, 20006, US

(21) Appl. No.: 12/990,715

(22) PCT Filed: May 5, 2008
(86) PCT No.: PCT/IL08/00608

§ 371 Date: Nov. 2, 2010

(51) Int. Cl. F02G 3/00; C06B 21/00; C08B 15/06

(52) U.S. Cl. 60/39.12; 422/163; 204/157.68

(57) ABSTRACT

An apparatus and method for in situ gas-phase formation and deflagration of nitrocellulose. A nitrating agent such as nitric acid and cellulose are delivered separately to a reaction chamber, where a brief heating pulse initiates nitration of the cellulose and deflagration of the nitrocellulose thus produced. Discharge of the high-pressure gases produced by the deflagration from the reaction chamber can then be used to drive an actuator, turbine, etc.

### FIELD OF THE INVENTION

This invention relates to methods of manufacture of nitrocellulose, in particular, in situ manufacture in the gas-phase in a reaction chamber. This invention also pertains to an apparatus for in situ gas-phase manufacture of nitrocellulose.

### BACKGROUND OF THE INVENTION

Since its discovery in 1846, nitrocellulose has been well-known as an energetic material. Many of its properties, for example, the low cost of its components, the large amount of energy stored within it, its ability to give off that energy even in the absence of oxygen, and its breakdown to products that do not include pollutants such as NOₓ or SOₓ, would make it an ideal anaerobic fuel (monofuel or monopropellant). One barrier to its use as such has been the practical difficulty of obtaining nitrocellulose in a form useful as a fuel or propellant, namely into the gas phase.

Three patents in the prior art teach the manufacture of nitrocellulose by reaction of cellulose with nitric acid vapor. U.S. Pat. No. 230,216 discloses a method for preparing nitrocellulose by using nitric acid vapor to nitrate cellulose in any suitable form. While the advantages of solvent-free preparation are clear even according to the method taught in this invention, the cellulose is provided in solid form and exposed to the vapors; hence, the nitrocellulose itself is not in the gas phase, and hence not suitable for use as a fuel or propellant. An additional method of producing nitrocellulose from the reaction of nitric acid vapor and cellulose is taught in U.S. Pat. No. 1,780,151. As this method also uses solid cellulose, it too is unsuitable for producing a monofuel or monopropellant. Finally, U.S. Pat. No. 4,334,060 teaches a process for gas phase nitration of cellulose. The process disclosed in that patent uses a constant stream of nitric acid vapor over a porous sheet of cellulose in order to produce nitrocellulose. While the nitrocellulose produced by this process is sufficiently homogeneous for use as a monofuel, the invention still suffers from the weakness that the nitrocellulose is formed in a separate chamber, and nitric acid is present in excess, so its vapors must be removed from the reaction chamber before the nitrocellulose can be used. All three of these inventions suffer from an additional difficulty, namely, that the formation of nitrocellulose within them takes place on a time scale typically of hours. For effective use of nitrocellulose as a fuel or propellant, in systems where it is formed from cellulose and a nitrating reagent, the formation of nitrocellulose must take place on a time scale of no more than seconds, and preferably on a time scale of no more than tens of milliseconds.

Ideally, production of nitrocellulose for use as a fuel or propellant would be performed not only in the gas phase, but in situ as well, that is, usable directly to provide energy to a device (e.g. an engine or turbine) without any need for further processing and transport. In addition, an ideal system for the in situ gas-phase production of nitrocellulose for use as a fuel or propellant would also combine the formation of the nitrocellulose with its combustion or deflagration in a single process. No such method or apparatus is taught in the prior art. Thus, there is a long felt need for such a method of in situ gas-phase nitrocellulose production and deflagration. The present invention is designed to meet this long-felt need.

### BRIEF DESCRIPTION OF THE INVENTION

It is thus an object of the present invention to provide a reaction chamber for in situ gas-phase preparation of and deflagration of a fuel, preferably nitrocellulose, comprising (a) means for independently introducing a plurality of precursors into and combining said precursors within said reaction chamber; and (b) means for deflagrating said fuel. It is within the essence of the invention wherein said preparation and deflagration of said fuel occur on a time scale measured in about tens of milliseconds.

It is a further object of the present invention to provide an engine characterized by at least one reaction chamber as described above and at least one actuator such that discharge of gases produced by deflagration of said fuel actuates said actuator.

It a further object of the present invention to provide an apparatus for in situ gas-phase preparation and deflagration of nitrocellulose, comprising (a) at least one container for accommodating a nitrating agent (NAC); (b) at least one container for accommodating cellulose (CC), (c) at least one reaction chamber as described above, each of said at least one reaction chamber interconnected with at least one of said at least one container for a nitrating agent and further interconnected with at least one of said at least one container for cellulose, said reaction chamber characterized by (1) it is resistant to attack by concentrated nitric acid; (2) it is adapted for use at effective pressure for in situ production and deflagration of nitrocellulose; (3) it is leak-proof; (4) it has at least one heating plug and/or spark plug passing through an external wall of said reaction chamber; (5) it has an inlet for cellulose, said inlet passing through an external wall of said reaction chamber and interconnected to said outlet of said cellulose container; (6) it has an inlet for a nitrating agent, said inlet passing through an external wall of said reaction chamber; (7) it has a nozzle, interconnected with said inlet for a nitrating agent, said nozzle adapted to convert a flow of a fluid to a spray and/or mist; (8) it has means for discharging gases formed in a chemical reaction occurring within said reaction chamber. It is within the essence of the invention wherein said apparatus is adapted for (a) rapid in situ formation of nitrocellulose in the gas phase; (b) rapid in situ deflagration of said nitrocellulose; (c) directional discharge of high-pressure gases formed during said deflagration.

It is a further object of this invention to provide such an apparatus, in which said at least one heating plug and/or spark plug is adapted to heat said reaction chamber to a temperature from about 230° C. to about 270° C.

It is a further object of this invention to provide such an apparatus, further comprising means for maintaining said container for accommodating cellulose under an inert atmosphere.

It is a further object of this invention to provide such an apparatus, in which said nitrating agent container and/or said cellulose container has characteristics chosen from the group consisting of (a) it isolates the fuel precursor from at least one of heat, static electricity, sparks, lightning, fire, shock, water, shock waves; (b) it is fully armor protected against light firearms and/or RPGs; (c) it is provided with self-cooling and dry-air systems adapted to keep said stored anaerobic fuel at a temperature of not more than about 35° C. and not less than about −20° C.; (d) it is storable in vacuum conditions; (e) it is storable under normal atmospheric weather conditions; (f) it is characterized by a container-within-a-container arrangement.

It is a further object of this invention to provide such an apparatus, in which said reaction chamber is further characterized by a pressure relief valve.

It is a further object of this invention to provide such an apparatus, in which said means for delivering a predetermined amount of nitrating agent from said container to a predetermined location external to said container are characterized by (1) a valve, said valve adapted to enable and/or to prevent flow of the contents of said container from said container to said predetermined location external to said container; (2) means for pumping at a predetermined rate the contents of said container from said container to said predetermined location external to said chamber.

It is a further object of this invention to provide such an apparatus, in which said means for delivering a predetermined amount of nitrating agent from said container to a predetermined location external to said container are characterized by (1) a valve, said valve adapted to enable and/or to prevent flow of the contents of said container from said container to said predetermined location external to said container; (2) means for pumping at a predetermined rate the contents of said container from said container to said predetermined location external to said chamber.

It is a further object of this invention to provide such an apparatus, further comprising a controller adapted to control at least one of the components of the apparatus according to a predetermined protocol.

It is a further object of this invention to provide such an apparatus, adapted to drive a turbine.

It is a further object of this invention to provide such an apparatus, adapted to drive a piston engine.

It is a further object of this invention to provide such an apparatus, adapted to drive a gas turbine.

It is a further object of this invention to provide such an apparatus, adapted to drive a rotary engine.

It is a further object of this invention to provide a method for in situ gas-phase formation of nitrocellulose, comprising the steps of: (a) obtaining an apparatus of the type described above; (b) obtaining a nitrating agent; (c) introducing a predetermined quantity of said nitrating agent into said container for a nitrating agent; (d) obtaining cellulose; (e) introducing a predetermined quantity of said cellulose into said container for cellulose; (f) transferring a predetermined quantity of said cellulose from said container for cellulose to said reaction chamber; (g) transferring a predetermined quantity of said nitrating agent from said container for a nitrating agent to said reaction chamber; (h) applying a predetermined voltage to said heating plug and/or high voltage spark plug for a predetermined period of time; (i) waiting a predetermined time; (j) repeating steps (f) through (i). It is within the essence of the invention wherein heat provided by said heating plug and/or spark plug initiates reaction between said nitrating agent and said cellulose, and further wherein said reaction between said nitrating agent and said cellulose yields rapid in situ gas-phase formation of nitrocellulose.

It is a further object of this invention to provide such a method, in which formation of nitrocellulose is followed by rapid predetermined deflagration of said cellulose.

It is a further object of this invention to provide such a method, in which said nitrating agent is chosen from the group consisting of (a) concentrated nitric acid; (b) dilute nitric acid; (c) NO₂; (d) a mixture of NO₂ and H₂O; (c) any other substance capable of nitrating cellulose in the gas phase; (e) any combination of the above.

It is a further object of this invention to provide such a method, in which said cellulose is provided in a form chosen from the group consisting of (a) solution; (b) suspension; (c) gel; (d) granules; (e) flakes; (f) grains; (g) pellets; (h) fibers; (i) roll; (j) straw; (k) paper; (l) any other form capable of undergoing gas-phase nitration; (m) any combination of the above.

It is a further object of this invention to provide such a method, comprising the further step of controlling steps (f) through (i) by a controller according to a predetermined protocol.

### BRIEF DESCRIPTION OF THE DRAWINGS

FIG. 1 shows an assembly drawing (not to scale) of a preferred embodiment of the apparatus disclosed in the present invention.

FIG. 2 shows an assembly drawing (not to scale) of an additional embodiment of the apparatus disclosed in the present invention.

FIG. 3 shows an assembly drawing (not to scale) of an additional embodiment of the apparatus disclosed in the present invention, comprising two sets of reagent containers, each of which supplies reagents to one of two independent reaction chambers.

FIG. 4 shows an assembly drawing (not to scale) of an additional embodiment of the apparatus disclosed in the present invention, in which two independent reaction chambers are supplied by a single set of reagent chambers.

FIG. 5 shows an assembly drawing (not to scale) of the apparatus disclosed in the present invention, adapted for use for driving a turbine.

FIG. 6 shows an assembly drawing (not to scale) of the apparatus disclosed in the present invention, adapted for use for driving a gas turbine (e.g. a jet engine).

FIG. 7 shows an assembly drawing (not to scale) of the apparatus disclosed in the present invention, adapted for use for driving a piston engine.

FIG. 8 shows an assembly drawing (not to scale) of the apparatus disclosed in the present invention, adapted for use for driving a rotary engine.

FIG. 9 shows an assembly drawing (not to scale) of the apparatus disclosed in the present invention, adapted for use for driving a rotary vane engine.

FIG. 10 shows the sequence of steps of in situ gas-phase formation and deflagration of nitrocellulose according to one embodiment of the method disclosed in the present invention.

FIG. 11 shows the results of experiment #1.

FIG. 12 shows the results of experiment #2.

FIG. 13 shows the results of experiment #3.

### DETAILED DESCRIPTION OF THE INVENTION

It will be apparent to one skilled in the art that there are several embodiments of the invention that differ in details of construction, without affecting the essential nature thereof, and therefore the invention is not limited by that which is illustrated in the figures and described in the specification, but only as indicated in the accompanying claims, with the proper scope determined only by the broadest interpretation of said claims.

As used hereinafter, the term “concentrated nitric acid” refers to an HNO₃/H₂O solution comprising about 70% to about 80% HNO₃ on a molar basis.

As used hereinafter, the term “highly concentrated nitric acid” refers to either (a) an HNO₃/H₂O solution comprising at least 80% HNO₃ on a molar basis or (b) pure (100%) HNO₃.

As used hereinafter, the term “dilute nitric acid” refers to an HNO₃/H₂O solution comprising less than about 70% HNO₃ on a molar basis.

As used hereinafter, the term “leak-proof” refers to a container designed such that when the designated inlet(s) and outlet(s) are closed, (a) material contained within cannot escape at a rate sufficient significantly to affect the operation of the apparatus (either by damage to the components of the apparatus or by significantly shortening the time needed between refills), and (b) material outside of the container (e.g. gases such as air or water vapor) cannot enter the chamber at a rate significantly to affect the operation of the apparatus (e.g. by degradation of the material within the container).

As used hereinafter, the term “inert atmosphere” refers to a gas or mixture of gases that has the properties of (a) the concentrations of O₂ and H₂O vapor are held below the minimum explosive limit for cellulose dust, and (b) the gas or mixture of gases does not react with cellulose during the time that the cellulose is stored under the gas or mixture of gases.

As used hereinafter, for the purpose of describing the conditions of a chemical reaction or formation of a substance, the term “gas phase” refers to any reaction of interest occurring in the absence of a solvent, including but not limited to reactions between gaseous reactants, reactions occurring at the interface between a gas and a solid or liquid surface, reactions that take place at the surface of a solid particle suspended in a gas, and reactions in which one of the reactants is present in the form of an aerosol.

As used hereinafter, the term “fuel component” or “component” refers to any or all of the components (i.e. the nitrating agent and the cellulose) from which the nitrocellulose fuel is generated in situ.

As used hereinafter, the term “nitrating agent container” or “NAC” refers to a container for storage of a nitrating agent, said container characterized by (1) it is constructed of materials resistant to attack by said nitrating agent; (2) it is leak-proof; (3) it has a sealable inlet; (4) it has a sealable outlet; (5) it has a means for delivering a predetermined quantity of its contents to a predetermined location external to said container.

As used hereinafter, the term “cellulose container” or “CC” refers to a container for storage of cellulose, said container characterized by (1) it has a sealable inlet; (2) it has a sealable outlet; (3) it is leak-proof; (4) it is of airtight construction when said inlet and outlet are closed; and, (5) it has means for delivering a predetermined quantity of the contents of said container from said container to a predetermined location external to said container.

As used hereinafter, the term “rotary engine” refers to any type of engine that uses a rotary design to convert energy provided by a fuel to rotational motion. While the archetypical example of a rotary engine is the Wankel-type rotary engine, the term refers to any kind of engine based on the principle, for example, the W. J. Ideal Rotary Engine™ disclosed in U.S. Provisional Pat. Appl. No. 60/935,522, which is hereby incorporated by reference.

As used hereinafter, the term “rotary vane engine” refers to any type of engine in which a plurality of vanes attached to a central rotor form chambers in the engine. While any engine based on this principle is included in the definition, one specific example is the high-power rotor engine disclosed in U.S. Provisional Pat. Appl. No. 61/043,749, which is hereby incorporated by reference.

As used hereinafter, the term “engine chamber” refers to any internal space within an engine within which one of the steps of the engine cycle takes place and/or any internal space within an engine into which gas can be introduced and from which gas can be exhausted, the motion of the gas causing motion of at least one component of the engine (e.g. a rotor).

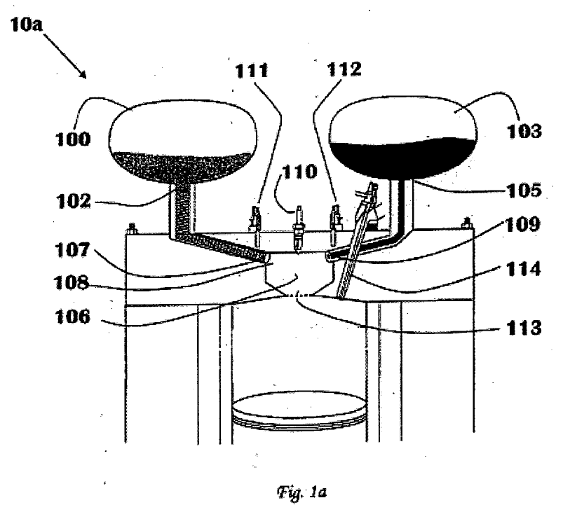

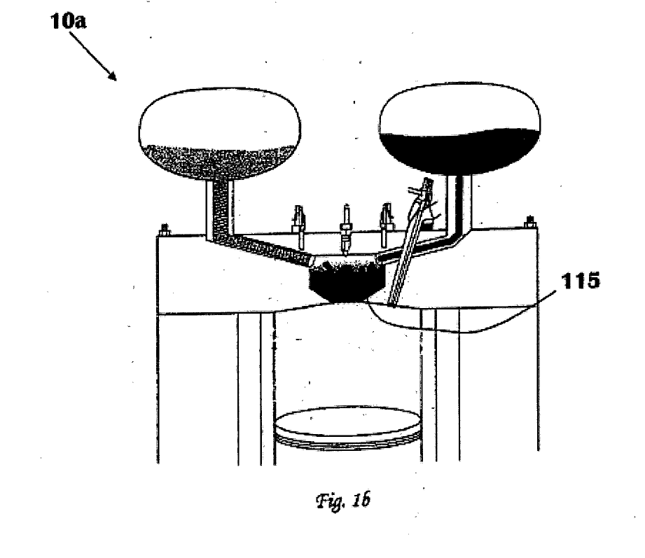

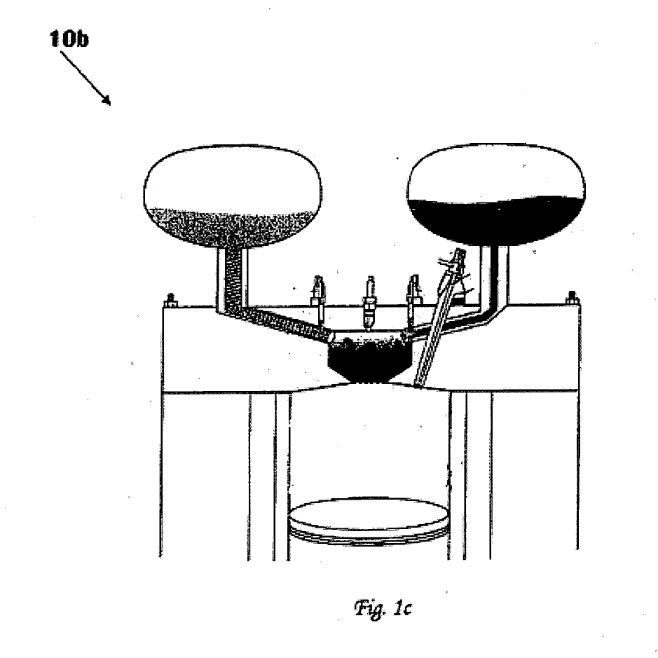

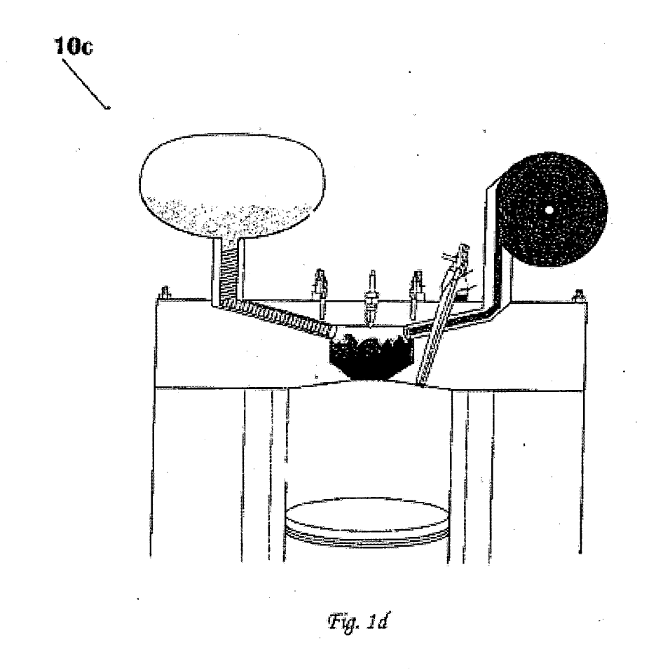

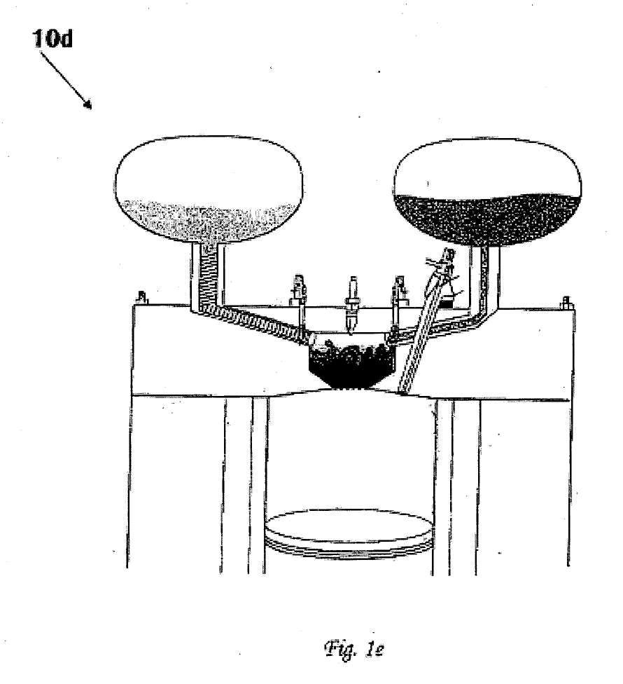

Reference is now made to the group FIG. 1, which show assembly drawings (not to scale) of a family of embodiments of the present invention. Nitrocellulose is produced from two components, a nitrating agent and cellulose. A preferred embodiment 10a is shown in FIG. 1a. The nitrating agent (typically highly concentrated nitric acid) is stored in NAC 100. In particular, the container is constructed out of material resistant to attack by highly concentrated HNO₃, e.g., type 316L stainless steel. It is also designed to be leak-proof so that the nitrating agent cannot escape and possibly damage other components of the invention. It is acknowledged and emphasized that the operation of the apparatus is independent of the size of the container for the nitrating agent. The actual volume of the container will depend on the specific needs of the operator according to considerations such as, e.g., the amount of available space, the rate at which the nitrating agent is used, and so on. An example of an NAC that meets the criteria for use in the present invention is the commercially available W.J. Acidic ISO Container™. The nitrating agent is introduced into the storage container via an inlet 101; when the inlet is closed, it is sealed to prevent escape of the nitrating agent or its vapors; the seal is effected by a substance that is resistant to attack by nitrating agents, e.g. Viton®. The nitrating agent exits the container via a dedicated outlet 102. This outlet is also sealable such that when it is closed, the nitrating agent cannot escape from the container. In the preferred embodiment shown in FIG. 1, the container for the nitrating agent is sealed by a valve 110, which, like the rest of the container, is manufactured from materials (e.g. type 316L stainless steel body and Viton® seals) resistant to attack by the nitrating agent. The valve may be chosen from, in a non-limiting manner, a mechanical valve, an electric valve, a pneumatic valve, and electropneumatic valve, or any other kind of valve that (a) can effect the required seal (sufficient to prevent leakage of the nitrating agent or its vapors from the container) when closed, (b) while open will permit the nitrating agent to flow out of the container at any rate predetermined by the user, and (c) the surfaces wetted by the nitrating agent are made of materials resistant to it (e.g. ceramic, glass, etc.). In the preferred embodiment shown in FIG. 1a, the valve 111 is adapted for remote actuation by an external controller. In the preferred embodiment shown in FIG. 1a, the flow of nitrating agent from the storage chamber is effected by a pump (which can be of any type suitable for transport of the nitrating agent). In the preferred embodiment illustrated in FIG. 1a, the predetermined rate at which nitrating agent flows from the NAC to its desired final location outside of the container (normally the reaction chamber) is controlled by (a) the speed of the pump; (b) the conductance of valve 111; and (c) the conductance of the pipe, tube, or other channel through which it flows. Normally, the apparatus will be constructed such that the flow of the nitrating agent from its container is limited only by the speed of the pump, but the construction of the apparatus is not limited to this case alone. It is acknowledged and emphasized that the actual rate of flow of the nitrating agent will depend on the specific needs of the user, and will be set by the user at the point of use in order to optimize the specific operation conditions of operation in practice.

In the preferred embodiment shown in FIG. 1a, cellulose is stored in a CC 103. This container is independent of the NAG described above. It is acknowledged and emphasized that the operation of the apparatus is independent of the size of the CC. The actual volume of the CC will depend on the specific needs of the operator according to considerations such as, e.g., the amount of available space, the rate at which the cellulose is used, and so on. The CC is leak-proof; in this case, the primary concern is degradation of the cellulose within the container due to reaction with oxygen or water vapor in any air that leaks in, or with the nitrating agent in the event of a catastrophic failure of the storage container for the nitrating agent. Cellulose is introduced to the CC via an inlet 104, and exits via an outlet 105. Both the inlet and the outlet are sealable such that when both are closed, the cellulose storage container is airtight. In the preferred embodiment depicted in FIG. 1a, the outlet seal is effected by a valve 112. The valve may be chosen from, in a non-limiting manner, a mechanical valve, an electric valve, a pneumatic valve, and electropneumatic valve, or any other kind of valve that can effect the required seal (sufficient to prevent leakage of the nitrating agent or its vapors from the container) when closed, and while open will permit the nitrating agent to flow out of the container at any rate desired by the user. In the preferred embodiment shown in FIG. 1a, the valve 112 is adapted for remote actuation by an external controller. An example of a container that meets all of the criteria listed is the commercially available W. J. Cellulose Storage Container™. In the preferred embodiment shown in FIG. 1a, the flow of cellulose from the CC is effected by a pump (which can be of any type suitable for transport of the nitrating agent). In the preferred embodiment illustrated in FIG. 1a, the rate at which cellulose flows from the container to its desired final location outside of the CC is controlled by (a) the speed of the pump; (b) the conductance of valve 112; and (c) the conductance of the pipe, tube, or other channel through which it flows. Normally, the apparatus will be constructed such that the flow of cellulose from its container is limited only by the speed of the pump, but the construction of the apparatus is not limited to this case alone. It is acknowledged and emphasized that the actual rate of flow of the cellulose will depend on the specific needs of the user, and will be set by the user at the point of use in order to optimize the specific operation conditions of operation in practice.

The formation and predetermined deflagration and/or combustion of the nitrocellulose takes place in a reaction chamber 106. The reaction chamber is interconnected to the two storage chambers such that material can flow independently from each of the chambers into the reaction chamber and that no mixing of cellulose and the nitrating agent can occur outside of the reaction chamber. It is constructed of material (e.g., type 316L stainless steel, ceramic, etc.) that is (a) resistant to attack by the nitrating agent and (b) capable of withstanding the overpressure generated during use of the apparatus. The nitrating agent passes from the container 100 to the reaction chamber via an inlet 107, said inlet passing through an external wall of reaction chamber 106. In order to disperse the nitrating agent within the reaction chamber, the inlet is connected to a nozzle 108 such that the nitrating agent passes from the inlet into the nozzle and exits the nozzle in the form of a fine spray or mist. Cellulose passes from the container 103 to the reaction chamber via an inlet 109, said inlet passing through an external wall of the reaction chamber. In the preferred embodiment illustrated in FIG. 1a, a seal is formed (e.g. by welding in embodiments in which the apparatus is constructed of material that can be welded) around the exterior of each of the inlets 107 and 109 where the inlet passes through the exterior wall of the reaction chamber 106 such that pressurized gas cannot escape from the reaction chamber around the sides of the inlet. At least one heating plug and/or spark plug 110 passes through an external wall of the reaction chamber. In the preferred embodiment shown in FIG. 1a, the apparatus comprises a single heating plug and/or spark plug; additional embodiments may contain any number of heating plugs and/or spark plugs desired by the user. As with inlets 107 and 109, a seal is made between the exterior of the heating plug and/or spark plug and reaction chamber such that gases cannot escape from around the sides of the heating plug and/or spark plug. As a non-limiting example, the heating plug and/or spark plug can be welded directly to the exterior wall of reaction chamber 106 in cases where the materials of construction are appropriate for welding; or it can be mounted on a flange that is attached in a leak-proof fashion to the reaction chamber; or it can be screwed into a threaded hole adapted for insertion of a heating plug and/or spark plug; or it can be attached in any other way that is convenient for the particular application for which the apparatus is intended. The heating plug and/or spark plug is a commercially available tungsten plug, heated by resistive heating in a predetermined manner. In the preferred embodiment illustrated in FIG. 1a, sufficient voltage is applied to the plug to bring it to a temperature of about 230° C. to about 300° C. It is acknowledged and emphasized that the operation of the apparatus in this temperature range is not limited to the preferred embodiment or to any specific additional embodiment, and that the actual temperature at which the apparatus will be operated (and hence the detailed construction of the heating plug(s) and/or spark plug(s)) will be chosen by the user in order to optimize the performance of the apparatus under the specific conditions under which it is being used.

The reaction chamber 106 also comprises an exit 113 through which high-pressure gases formed during its operation are discharged. It is acknowledged and emphasized that the operation of the apparatus does not depend upon the details of the shape and size of the exit. The detailed construction of the exit will depend on the particular conditions of use, and the direction and intensity of gas flow desired by the user at the point of use. In the preferred embodiment illustrated in FIG. 1a, the apparatus additionally comprises a pressure relief valve set to vent the gases within should a sufficiently high internal pressure develop within the apparatus; typically, the pressure relief valve would be set to open if the pressure within reaches a value sufficiently high to rupture or otherwise damage the apparatus, minus a predetermined safety factor. It is acknowledged and emphasized that the use of a pressure relief valve is not limited to the preferred embodiment or to any specific additional embodiment.

In the preferred embodiment illustrated in FIG. 1a, the apparatus and all of its constituent parts (including, but not limited to, valves 111 and 112, heating plug 110, the rate at which nitrating agent and cellulose are supplied to reaction chamber 106, and the sequence and timing of the various stages of its use) are under the control of an external controller, e.g. a computer, programmed to run the apparatus. It is acknowledged and emphasized that the use of an external controller is not limited to the preferred embodiment or to any specific additional embodiment.

Reference is now made to FIG. 1b, illustrating a “snapshot” of a typical mixture 115 of nitrating agent and cellulose. The mixing under heating initiates reaction between the two components to form nitrocellulose.

Reference is now made to FIGS. 1c-1e, in which assembly drawings (not to scale) of additional embodiments 10b-10d are shown. These embodiments differ in the form in which the cellulose is provided. Thus, while in FIGS. 1a and 1b, it is provided as a solution, in the additional embodiment 10b, illustrated in FIG. 1c, the cellulose is in the form of a gel. In the additional embodiment 10c, illustrated FIG. 1d, the cellulose is provided in the form of a roll. Since in this embodiment, the cellulose is provided in a form that is self-supporting, container 103 is entirely optional. In the additional embodiment 10d, illustrated in FIG. 1e, the cellulose is provided in the form of grains or other small particles. It is within the scope of the invention to supply the cellulose in any form in which it can react in the gas phase with an appropriate nitrating agent to form nitrocellulose, and not just the forms given in the figures, which are for exemplary and illustrative purposes only.

In an additional embodiment of the apparatus (not illustrated), means are provided for storing the dry cellulose under an inert atmosphere (e.g., N₂). Isolation of the cellulose from atmosphere is advantageous, as cellulose (especially cellulose dust) is highly inflammable, long-term contact with the atmosphere will degrade the cellulose, and deflagration of the nitrocellulose can take place in the absence of oxygen in any case. In such embodiments, CC 103 will comprise an additional inlet through which the inert atmosphere is introduced. In additional embodiments, the inlet will pass through an external wall of the container, or additionally, it can be connected to inlet 104 such that the inert atmosphere is introduced into the container contemporaneously with the introduction of the cellulose. While under normal use, the inert atmosphere will be maintained at a pressure somewhat above atmospheric pressure (sufficient to prevent mass flow of air into the chamber), it is acknowledged and emphasized that the actual pressure of inert gas in embodiments in which the cellulose is held under inert atmosphere will be controlled and determined by the user. It is acknowledged and emphasized that storage of the dry cellulose under inert atmosphere is not limited to the preferred embodiment or to any specific additional embodiment.

In yet another additional embodiment of the apparatus, at least one storage unit is characterized by a container-within-a-container arrangement, and further has characteristics chosen from the group consisting of (a) it isolates the fuel precursor from at least one of heat, static electricity, sparks, lightning, fire, shock, water, shock waves; (b) it is fully armor protected against light firearms and/or RPGs; (c) it is provided with self-cooling and dry-air systems adapted to keep said stored anaerobic fuel at a temperature of not more than about 35° C. and not less than about −20° C.; (d) it is storable in vacuum conditions.

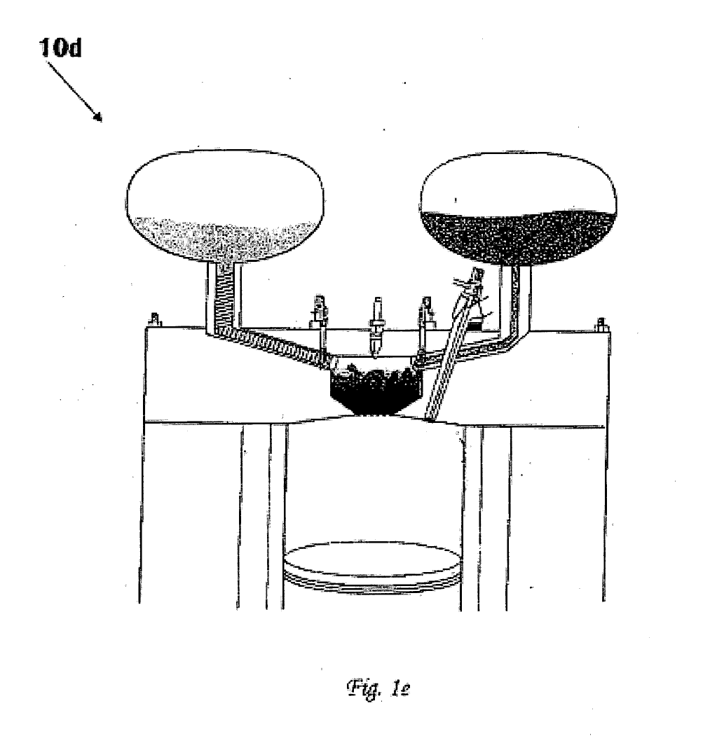

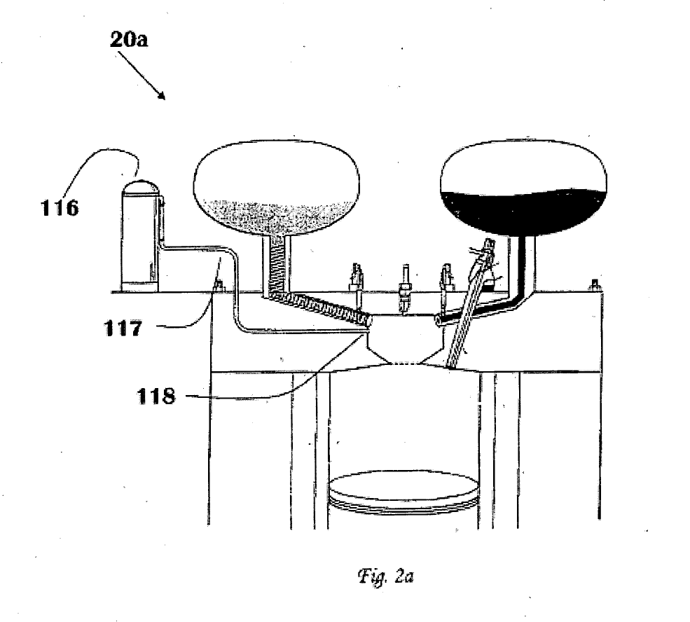

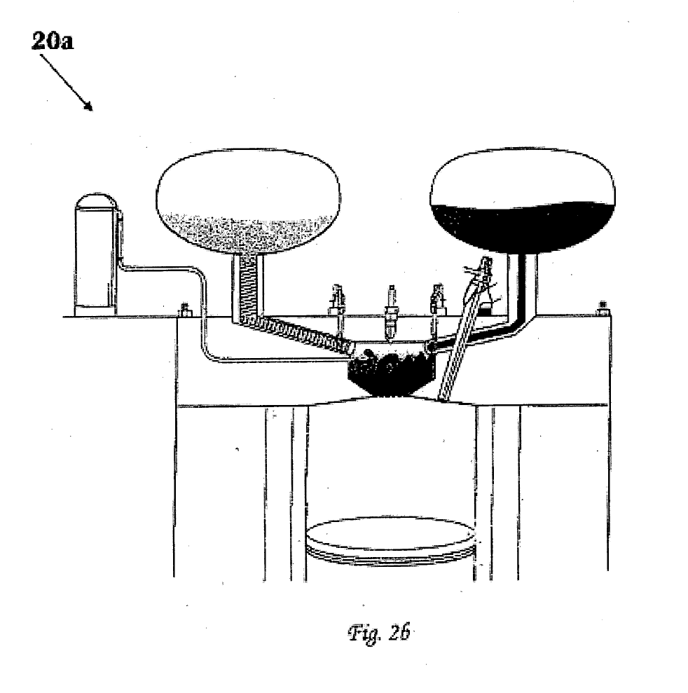

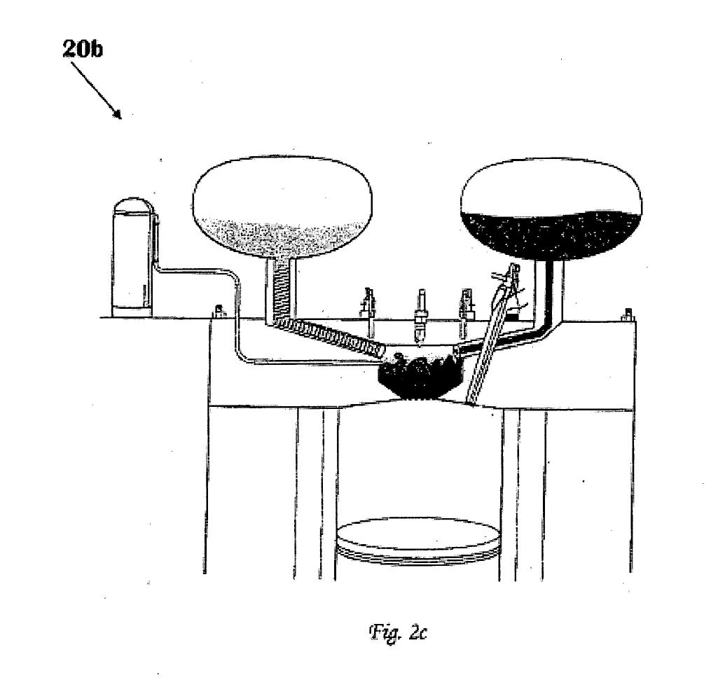

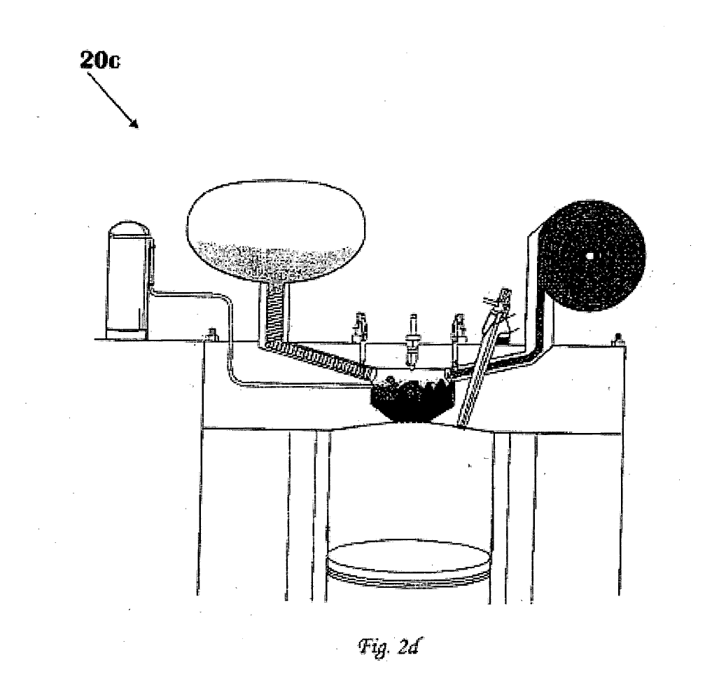

Reference is now made to the group FIG. 2, which illustrate assembly drawings (not to scale) of a family of additional embodiments 20a-20d. In these embodiments, the apparatus comprises a separate storage container 116 in addition to the containers for the nitrating agent and the cellulose. This additional container is adapted to accommodate a third substance. As a non-limiting example, this third substance can be, e.g., an oxidant, a dyestuff, an inhibitor, or any additional substance desired by the user to be introduced into the reaction chamber before, during, or after the in situ formation of cellulose. The storage container 116 is connected to the reaction chamber via an appropriate line 117 (the line 117 can be, e.g., a pipe, tube, channel, or any other means for transporting the material contained within container 116 to the reaction chamber). In the embodiment illustrated in FIG. 2, the additional material is introduced into the reaction chamber via an inlet 118 which passes through an external wall of the reaction chamber. As with inlets 107 and 109, a seal is constructed around inlet 118 such that pressurized gases cannot escape from the reaction chamber around the sides of the inlet. In additional embodiments, inlet 118 can be connected to any combination of reaction chamber 106, inlet 107, and inlet 109. FIGS. 2a and 2b illustrate an embodiment 20a in which the cellulose is supplied as a solution; FIG. 2b shows a “snapshot” of the mixing of the nitrating agent, the cellulose, and the ingredient contained in container 116. FIG. 2c illustrates an embodiment 20b in which the cellulose is supplied in the form of a gel. FIG. 2d illustrated an embodiment 20c in which the cellulose is supplied in the form of a roll. FIG. 2e illustrated an embodiment 20d in which the cellulose is supplied in the form of grains, flakes, or other small particles.

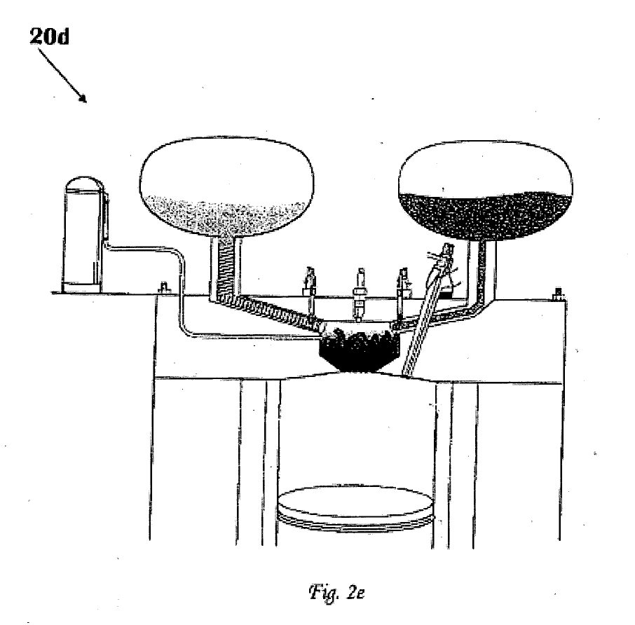

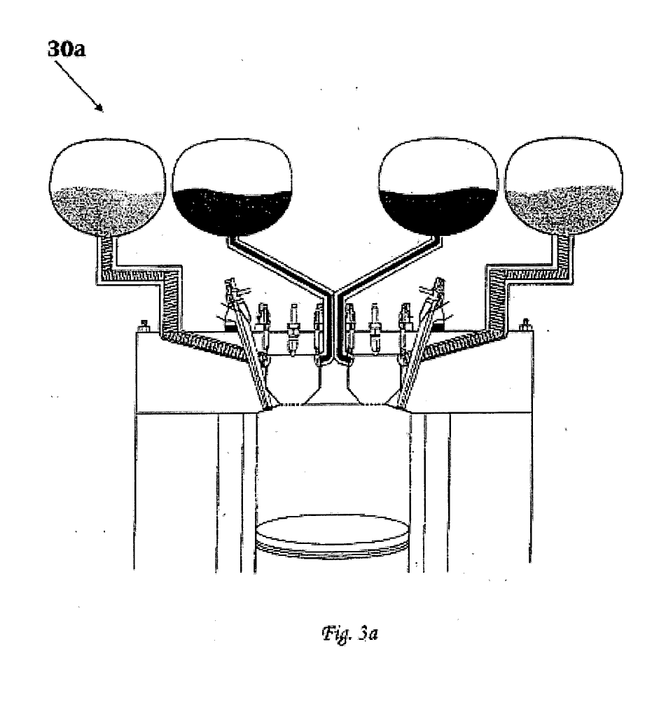

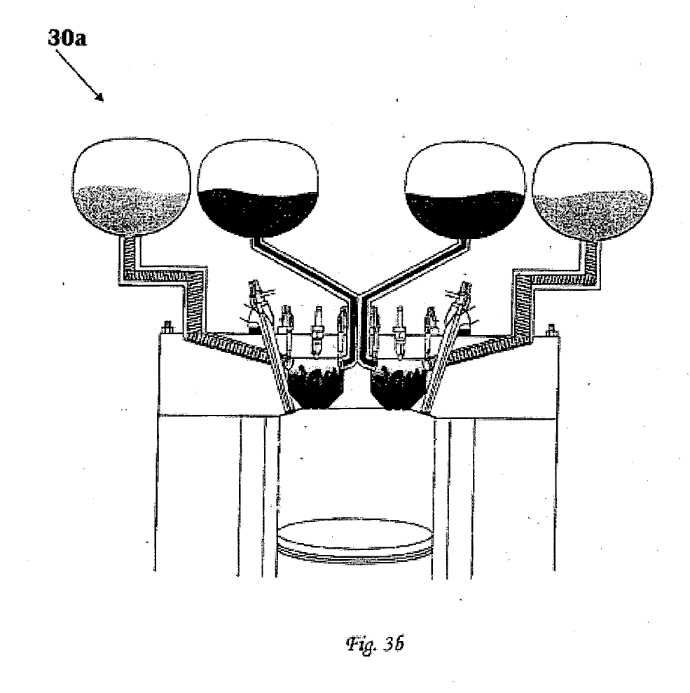

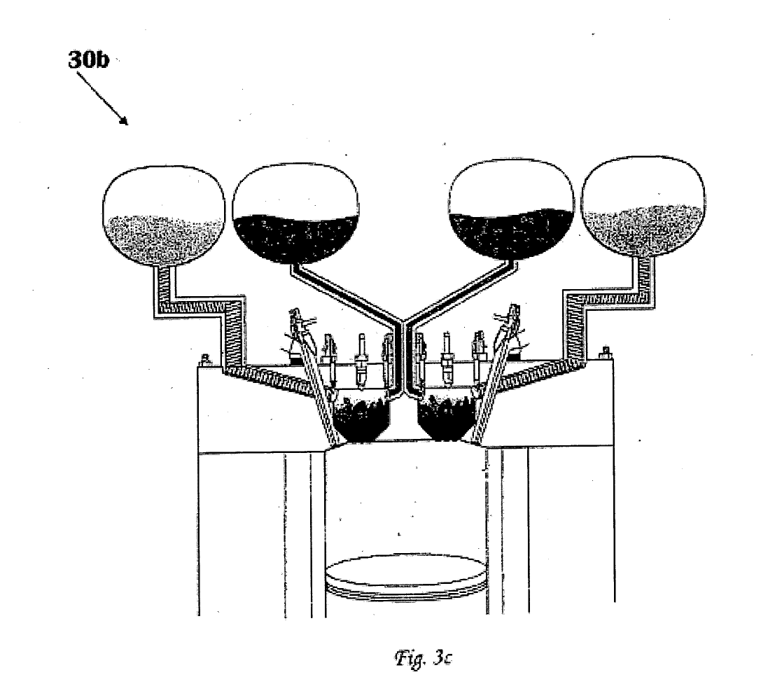

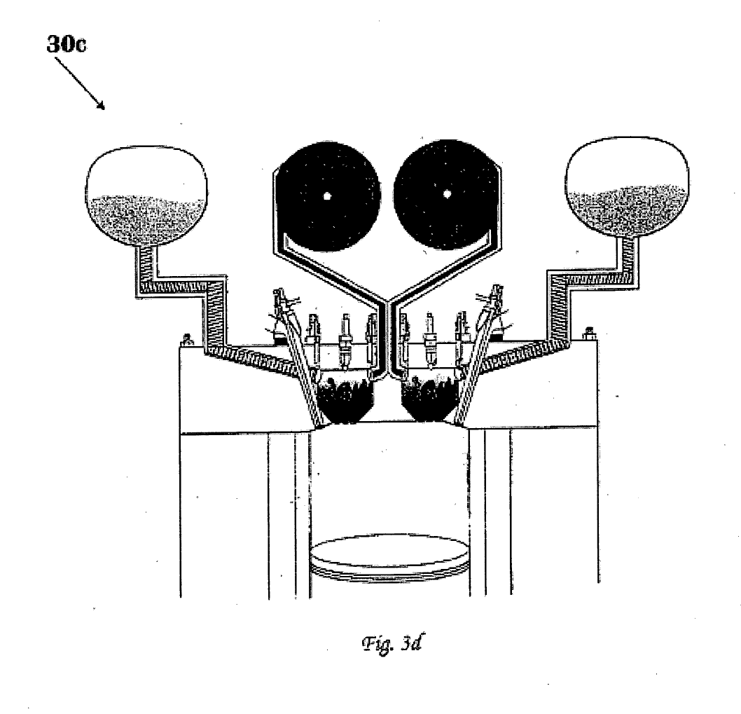

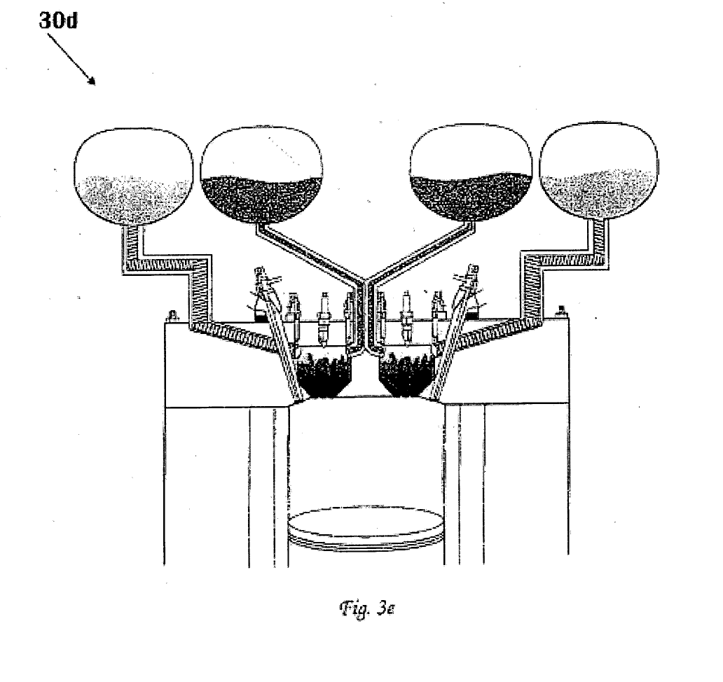

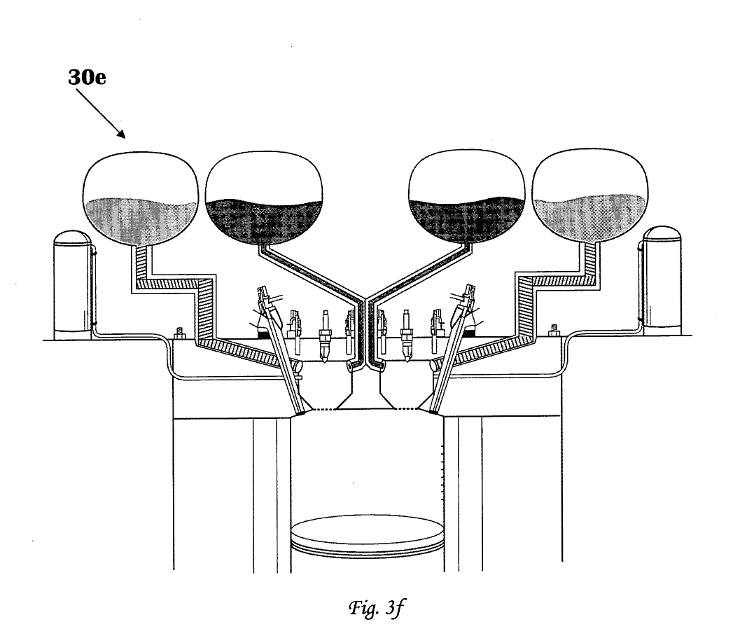

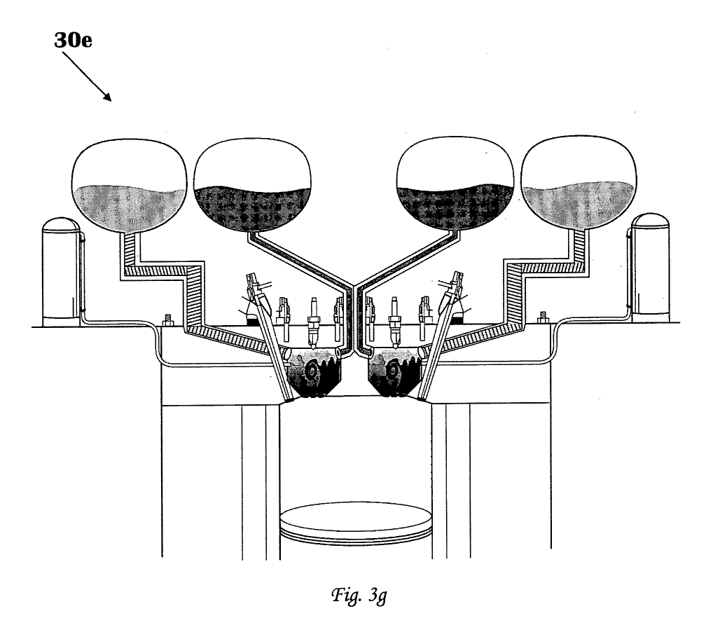

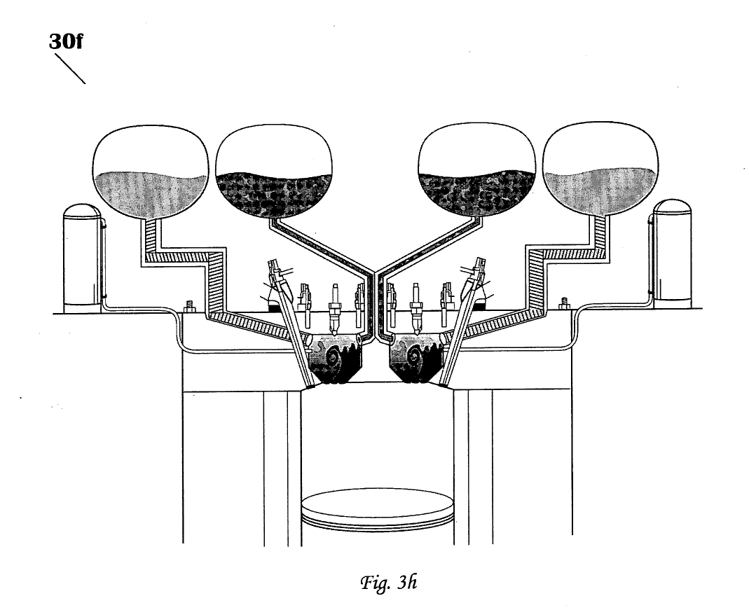

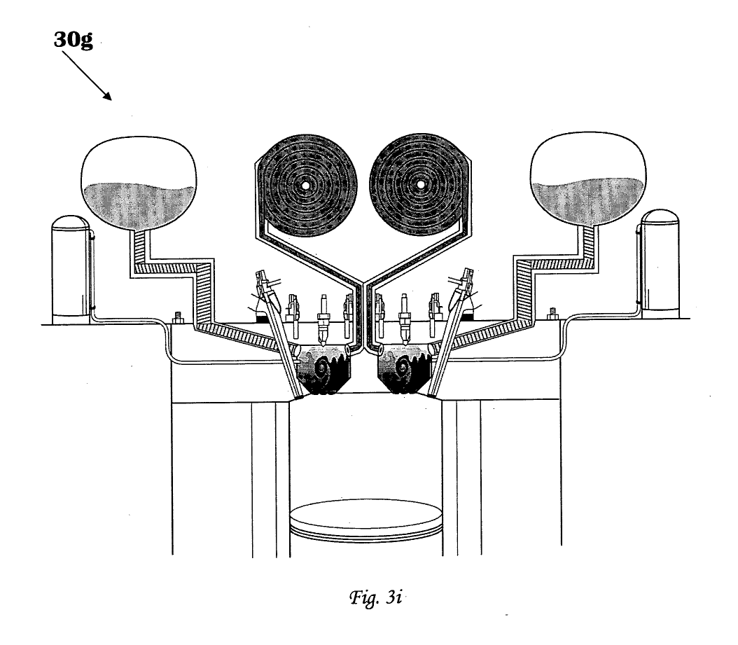

Reference is now made to the group FIG. 3. These figures show a family of additional embodiments in which the apparatus comprises more than one reaction chamber and more than one set of containers for the components from which the nitrocellulose is made. It is within the scope of the invention number of reaction chambers is not limited to two, nor is the number of sets of storage containers limited to two, nor is the ratio between the number of reaction chambers and the number of storage units set to any specific value. It is acknowledged and emphasized that FIG. 3 are given for exemplary and illustrative purposes only, in order to show the configuration of the apparatus when the number of reaction chambers and/or sets of storage units is more than one. FIG. 3a shows an additional embodiment 30a in which the apparatus comprises two reaction chambers. The nitrating agent and the cellulose are provided to the reaction chambers from two independent sets of storage containers. Each storage chamber is connected to one of the reaction chambers in a manner analogous to that described in detail for embodiment 10a. The introduction of the reagents to one reaction chamber is completely independent of its introduction into the other. It is acknowledged and emphasized that the details of the order and timing of the introduction of the materials into the reaction chamber are entirely at the discretion of the user. As a non-limiting example, FIG. 3b shows a “snapshot” of the mixing of the nitrating agent and the cellulose in an embodiment in which introduction of the materials occurs simultaneously in each of the two reaction chambers. FIG. 3c illustrates an embodiment 30b in which the cellulose is supplied in the form of a gel. FIG. 3d illustrates an embodiment 30c in which the cellulose is supplied in the form of a roll. FIG. 3e illustrates an embodiment 30d in which the cellulose is supplied in the form of grains, flakes, or other small particles. In FIG. 3f, an embodiment 30e is presented in which a third material is introduced into the reaction chambers. As above, this material is stored in a separate set of storage containers, each of which is connected to the appropriate reaction chamber in the manner described above for the case of a single set of storage containers. It is in the scope of the invention that each of the two additional storage containers may contain a different material. FIG. 3g illustrates a “snapshot” of the mixing of the materials within the reaction chambers; in this case, which is not to be taken as limiting, the mixing in the two chambers occurs simultaneously. FIGS. 3h-3j illustrate additional embodiments 30f, 30g, and 30h, in which the cellulose is supplied in the form of a gel, a roll, and small particles (e.g. flakes or grains), respectively.

Reference is now made to the group FIG. 4, in which assembly drawings (not to scale) of a family of additional embodiments is presented. FIG. 4a illustrates embodiment 40a, in which two independent reaction chambers are supplied from a single set of storage units. Each storage unit has two outlets, each of which is connected to an inlet of one of the reaction chambers. It is acknowledged and emphasized that a single storage container may supply any number of reaction chambers. The exact timing and sequence of the supply of materials from each of the storage units to each of the reaction chambers is determined by the user according to the specific needs of the specific use. FIG. 4b illustrates embodiment 40b, in which the cellulose is provided in the form of small particles (e.g. flakes, grains, or powder). FIG. 4c illustrates embodiment 40c, similar to embodiment 40b but additionally comprising two containers for additional material. Except for the change from multiple storage units for the nitrating agent and the cellulose, the details of this embodiment are identical to those of the analogous embodiment described above.

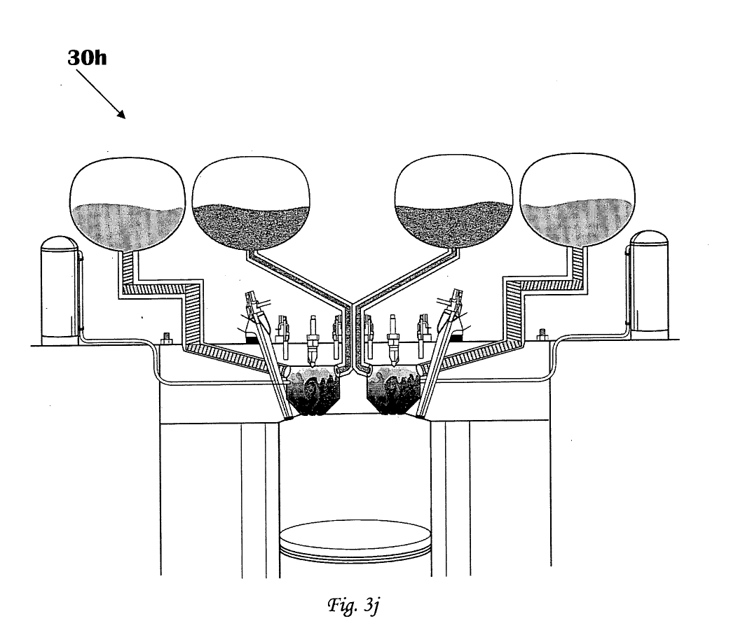

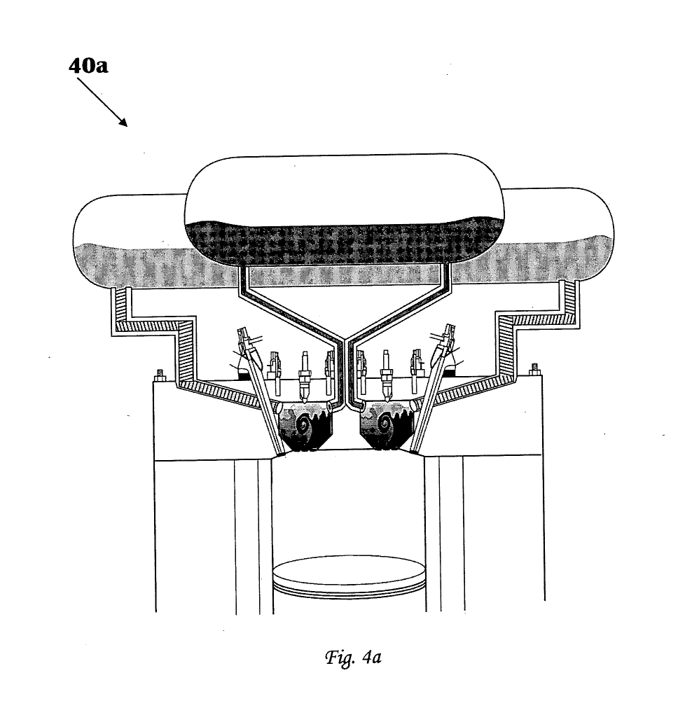

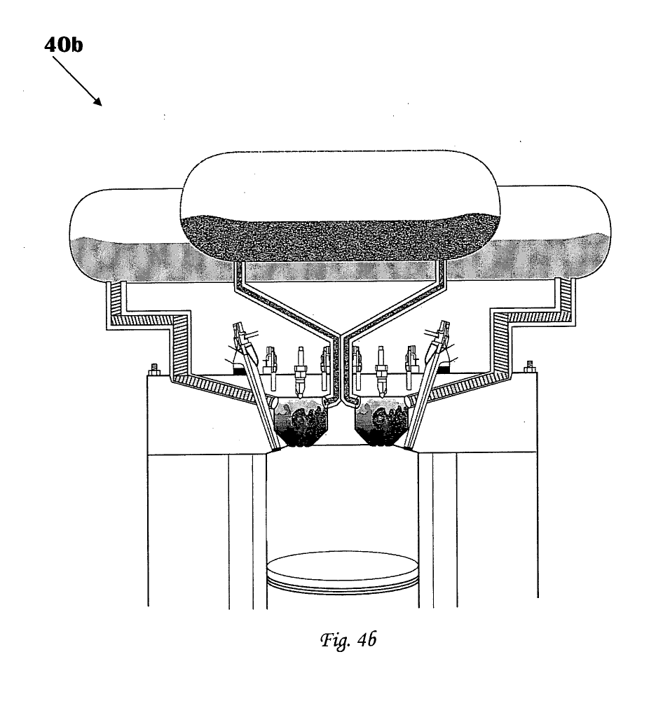

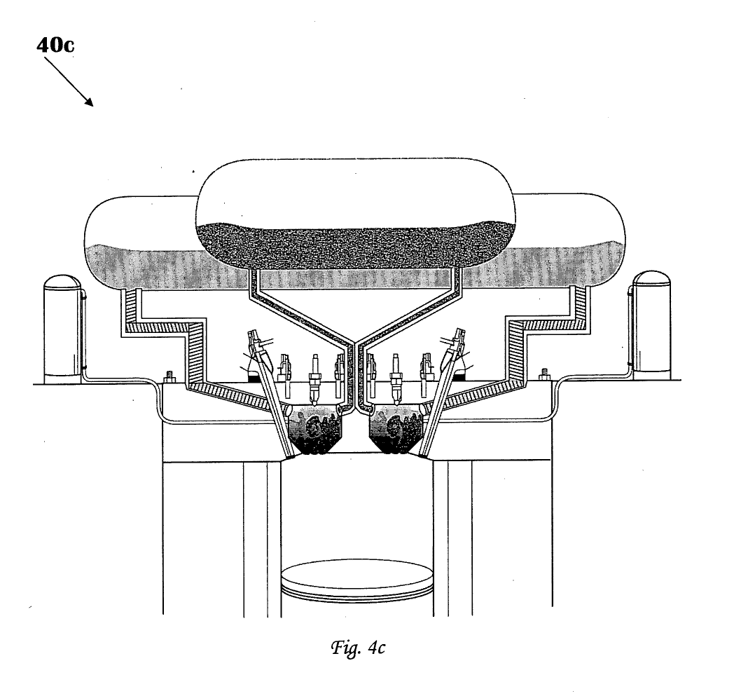

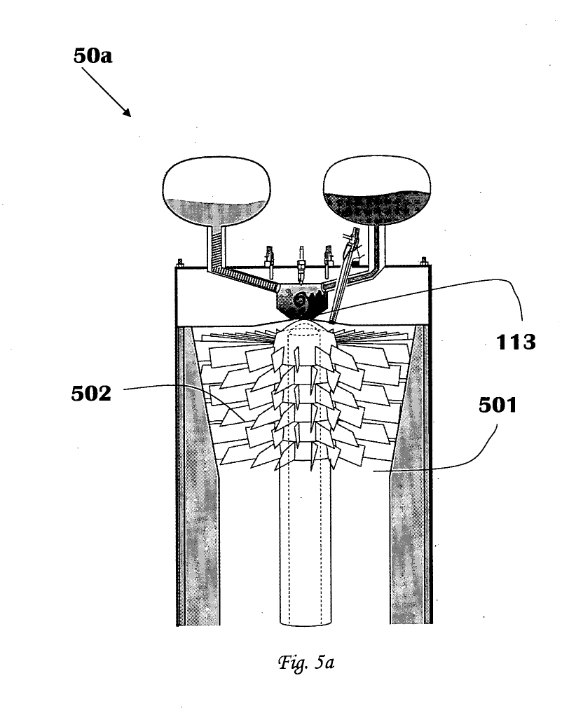

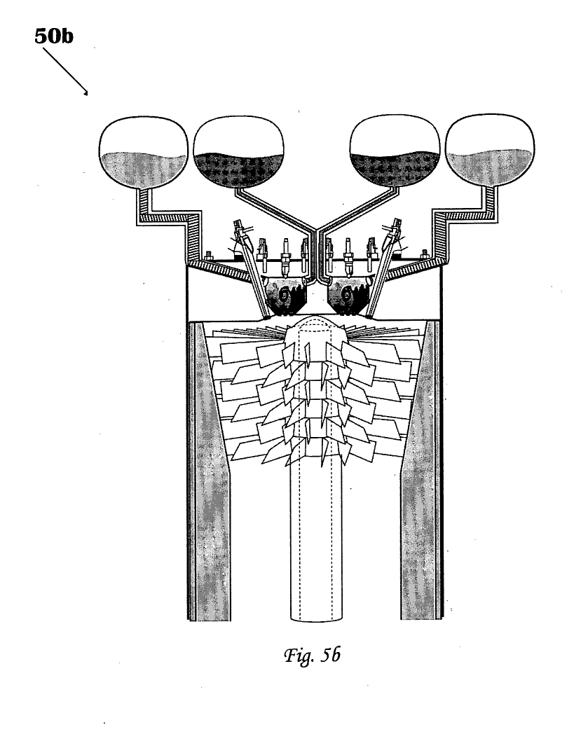

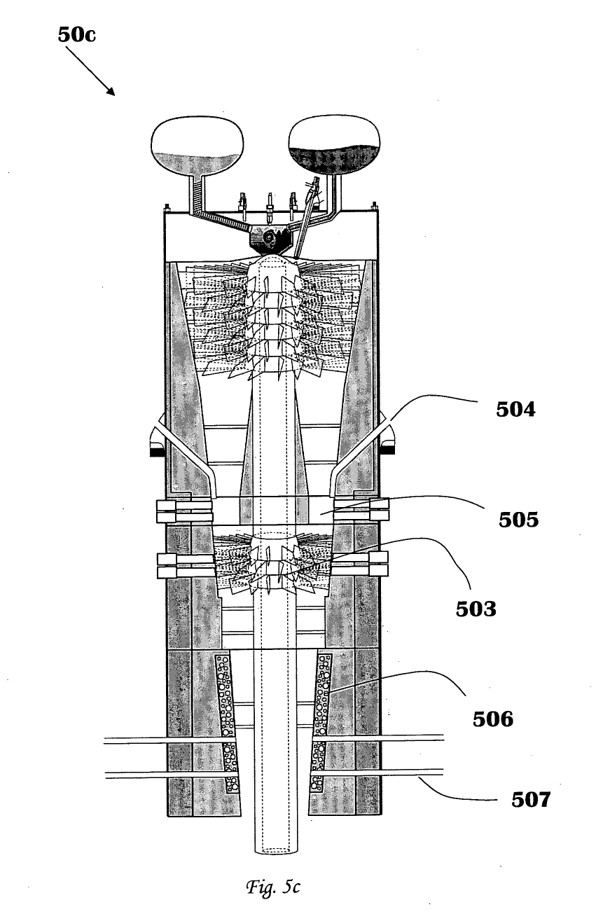

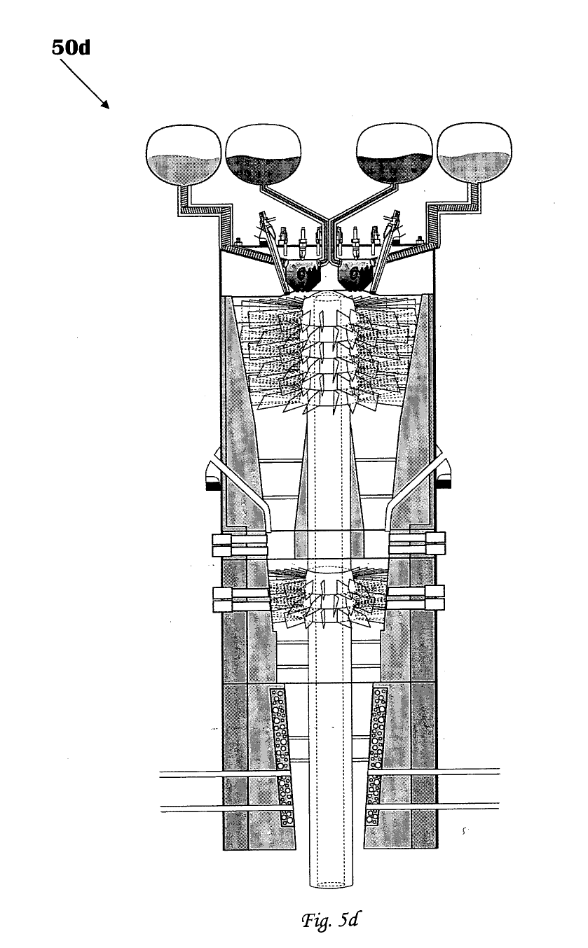

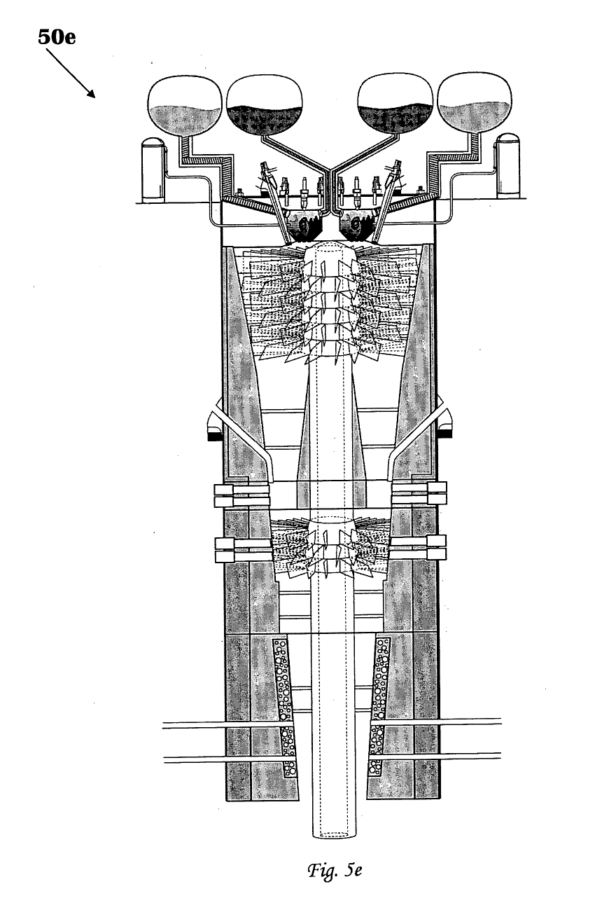

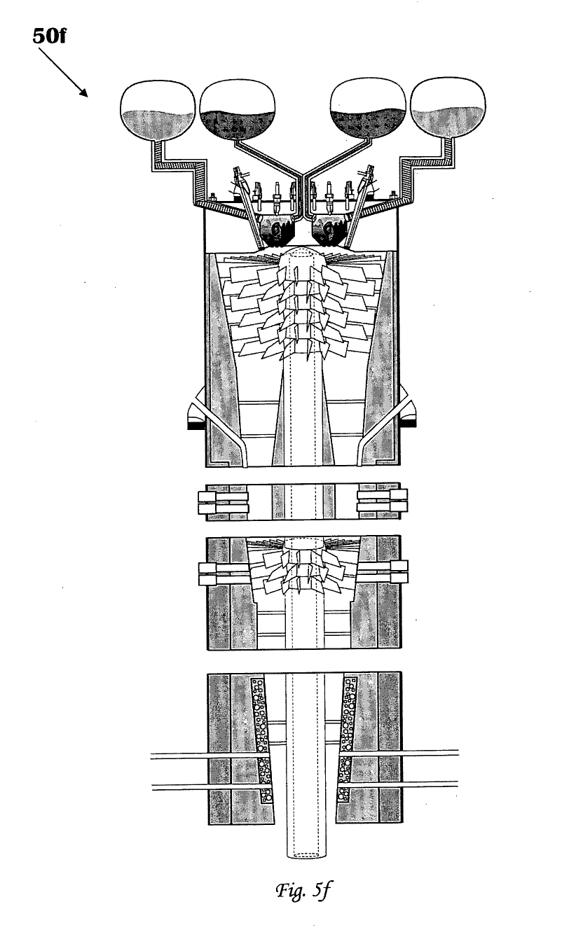

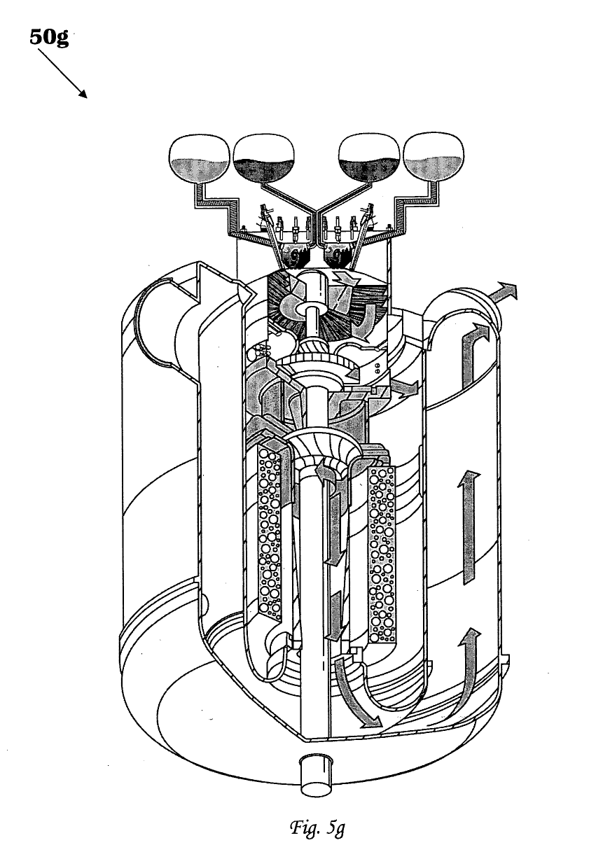

Reference is now made to the group FIG. 5, which show a family of embodiments in which the invention is adapted for use in driving a turbine (for example, the commercially available W. J. Turbine™). FIG. 5a illustrates (not to scale) an embodiment 50a comprising such an adaptation. The gas exhaust 113 is directed into a chamber 501 containing a turbine assembly 502. The gases produced in the deflagration of combustion of the fuel are discharged from the reaction chamber and the motion of the gases causes the turbine blades to turn. FIG. 5b illustrates an embodiment of such an adaptation (50b) in which two sets of fuel precursor containers supply the two precursors of the fuel to two independent reaction chambers. It is within the scope of the invention that the ignition of the fuel in each of the two chambers occurs independently of ignition in the other one. It is further in the scope of the invention that the timing and duration of the firing in the two chambers may be under the control of an external controller such as a computer. FIGS. 5c-5g illustrate embodiments 50c-50g in which the invention is used to drive a multi-stage turbine (e.g. the commercially available W. J. Multi-Stage Turbine™), comprising one and two sets of fuel precursor containers and reaction chambers respectively. In these embodiments, gases discharged from the reaction chamber(s) drive the first stage turbine as described above. The gases produced during anaerobic deflagration of nitrocellulose typically contain a significant inflammable fraction (up to 50%); this inflammable fraction normally comprises CO and H₂ as its principal components. Combustion of this inflammable fraction is used to drive a second-stage turbine assembly 503. Oxidant is introduced via an inlet system 504 and mixed with the gases discharged from the first-stage turbine assembly in entrance chamber 505. Movement of gases produced during the combustion of the inflammable fraction of the gases discharged from the reaction chamber 113 through the first-stage turbine causes the rotor of the second-stage turbine to turn. In the embodiments illustrated, the multi-stage turbine additionally comprises a heat exchanger 506. Having passed through the second-stage turbine, hot gases contact the heat exchanger, which accepts heat from them. A piping system 507 through which a fluid (e.g. a liquid or gas) flows is in thermal contact with the heat exchanger, enabling the heat accepted by the heat exchanger to be carried to any external location desired by the user. The figures illustrate a number of possible designs for the invention that can be used to drive such a turbine assembly. Embodiment 50c (FIG. 5c) comprises a single set of fuel precursor containers and a single reaction chamber, while embodiment 50d (FIG. 5d) comprises two. Embodiment 50e (FIG. 5e) additionally comprises additional containers, which can contain any additional substance (e.g. a dye, an inhibitor, etc.) or substances desired by the user. FIG. 5f illustrates embodiment 50f, in which the invention is adapted for use to drive a fully modular turbine assembly, an exploded view of which is shown in the figure. FIGS. 50g-50i illustrate yet another additional family of embodiments. In these embodiments, the present invention drives a turbine in which the hot gases produced by deflagration and/or combustion of the fuel are used first to drive the turbine and then as a source of heat for an additional application (e.g. heating a building). Embodiment 50g (FIGS. 5g and 5h) shows a construction comprising two sets of fuel precursor containers and two reaction chambers. The flow of gases through the apparatus is illustrated in FIG. 5h. Gases produced by deflagration and/or combustion of the fuel exit the reaction chambers and pass through the turbine chamber, driving the turbine (circles). The gases then flow through the apparatus and past a heat exchanger (stars), after which they are exhausted from the turbine apparatus (triangles). FIG. 5i illustrates embodiment 50h, in which the reaction chamber is designed such that the deflagration produces a sufficiently high temperature and pressure to measurably ionize the gases discharged from the reaction chamber. The flow of charged particles through the apparatus is used to drive a generator, the magnet of which surrounds the channel through which the gases flow. It is within the scope of the invention to include any number of reaction chambers, any number of fuel precursor containers, any physical size for the apparatus, any turbine design, and any other details of the construction and control of the apparatus. It is acknowledged and emphasized that the group of FIG. 5 is presented for illustrative and exemplary purposes only, and not to limit the present invention to the specific designs illustrated in the figures. The details of the construction of the adaptation of the present invention for use to drive a turbine will depend on the specific needs of the user, and the invention can be used for any power or energy output desired by the user.

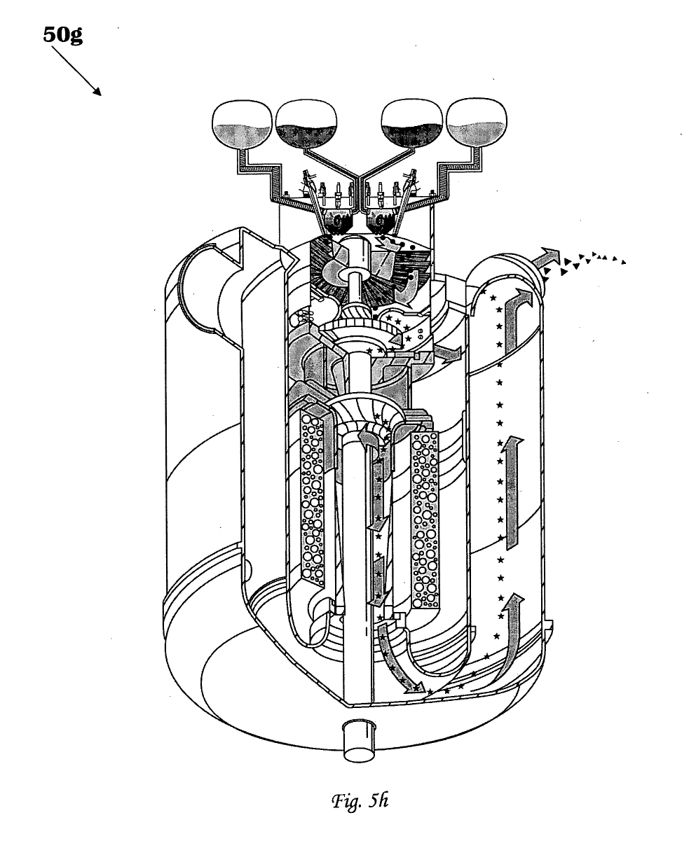

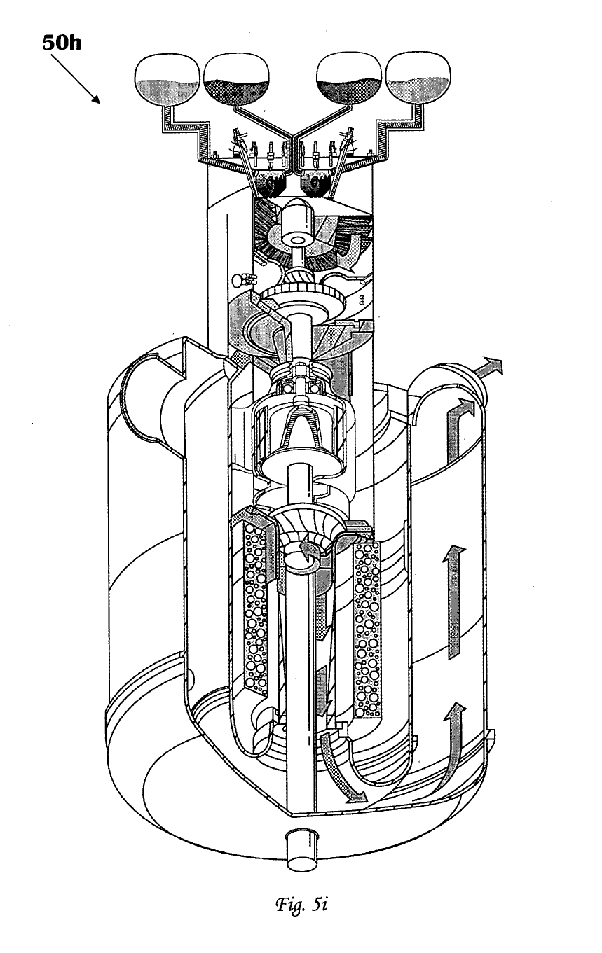

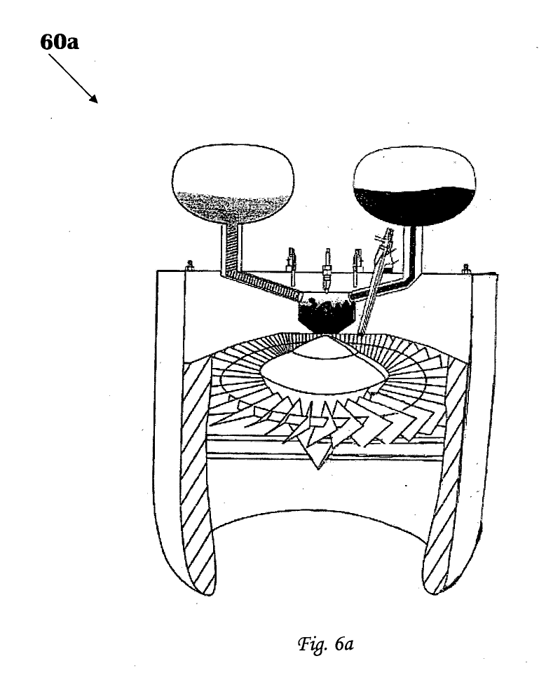

Reference is now made to the group of FIG. 6. These illustrate (not to scale) a family of embodiments of the invention in which it is adapted for use to drive a gas turbine of the sort used in, e.g., a jet airplane engine. FIG. 6a illustrates a means (embodiment 60a) by which the gases are discharged from the reaction chamber into a typical gas turbine (e.g. the commercially available W. J. Gas Turbine™), which is located in a housing of an appropriate design for its intended use. An additional embodiment (60b) is illustrated in FIG. 6b. This embodiment comprises two reaction chambers and two sets of fuel precursor containers. In addition, the turbine assembly shown comprises a dual-stage gas turbine analogous to those shown in embodiments 50c-50g. Again, it is acknowledged and emphasized that the embodiments presented in the figures are shown for exemplary and illustrative purposes only and are not intended to limit the construction of the apparatus to any specific design or size.

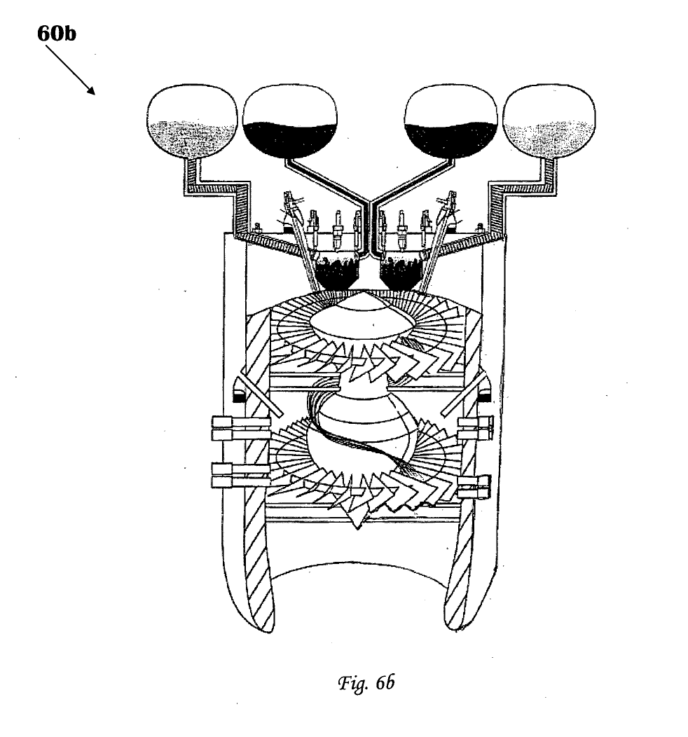

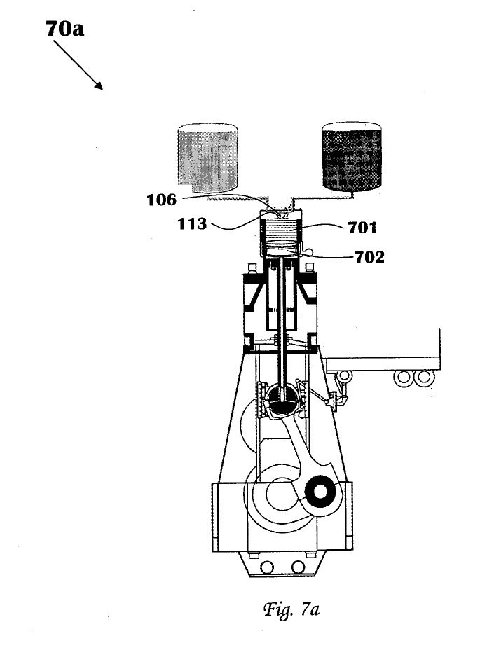

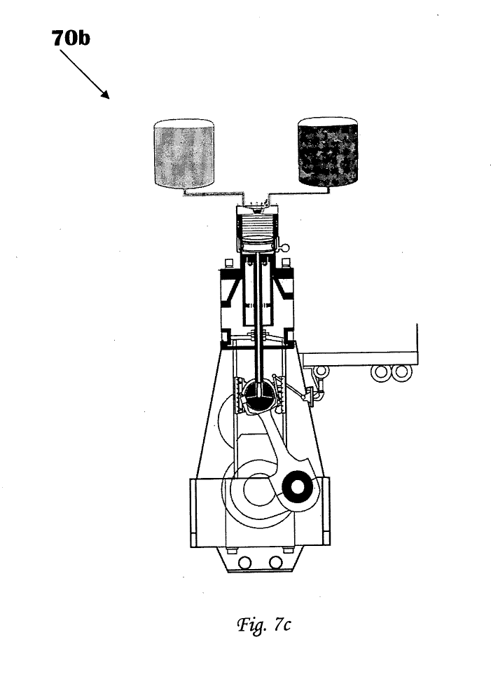

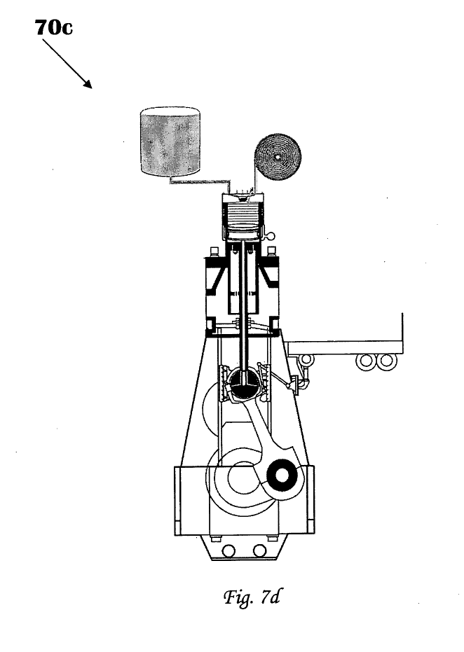

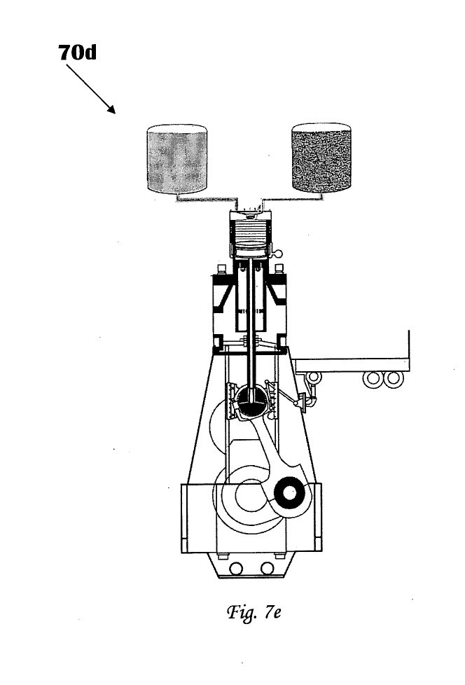

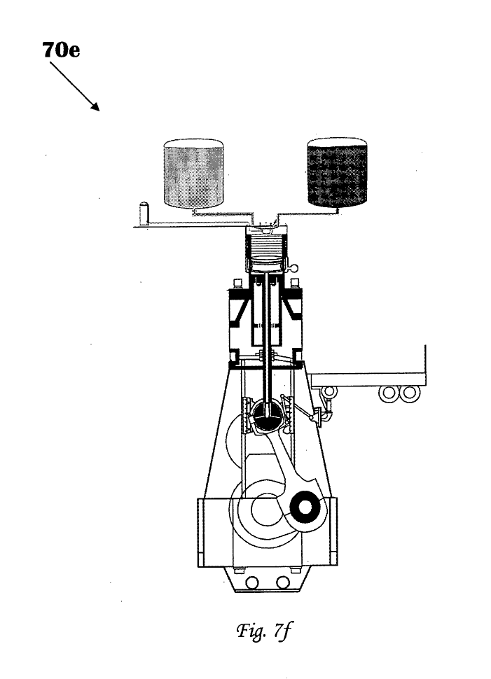

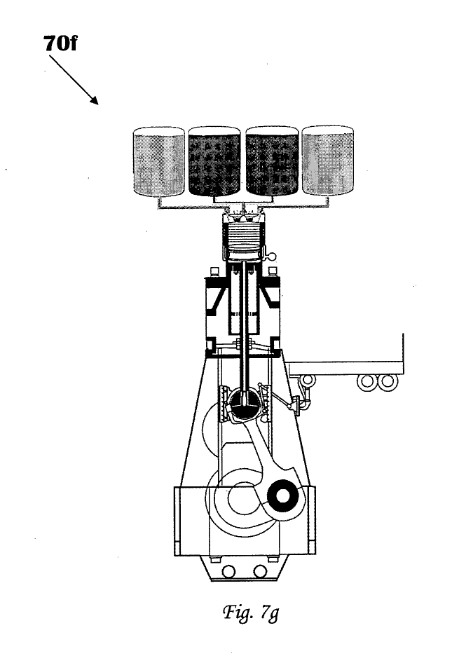

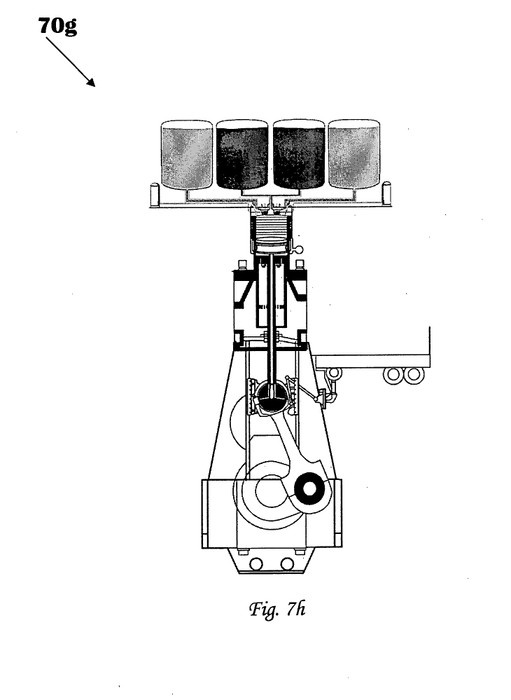

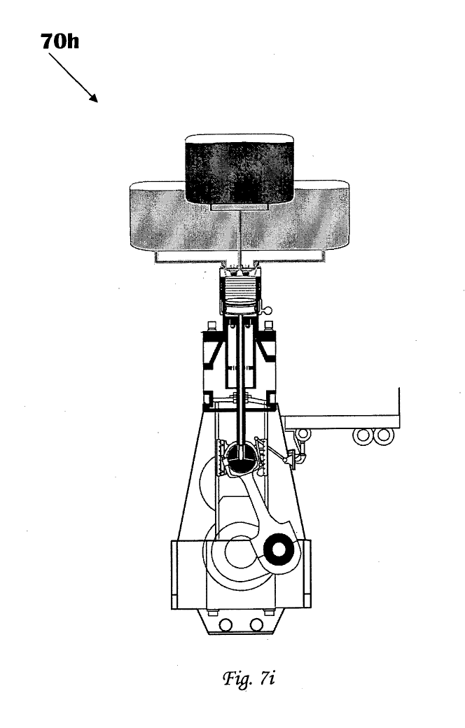

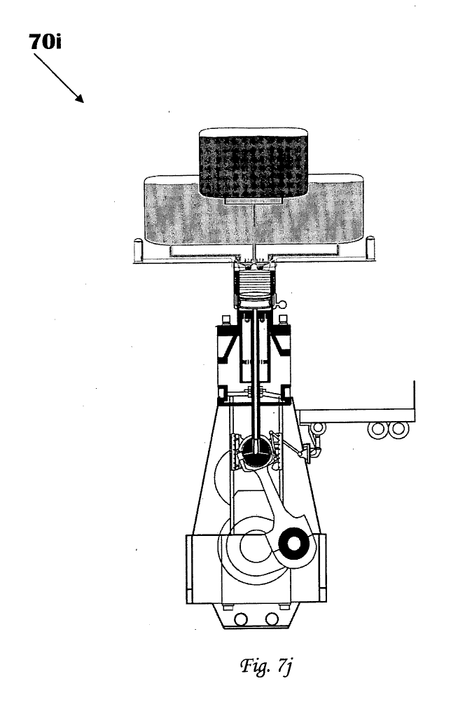

Reference is now made to the group of FIG. 7. These illustrate (not to scale) a family of embodiments of the invention in which it is adapted for use in a piston engine (e.g. the commercially available W. J. Ideal Engine™). After deflagration and/or combustion of the fuel in reaction chamber 106, the gases are discharged via exit 113 into cylinder 701. The expansion of the gases drives piston 702 and hence the reciprocating piston engine. The gases are discharged from the cylinder on the reciprocal stroke. FIG. 7 illustrate a number of embodiments of the present invention. FIG. 7a shows an embodiment (70a) in which the cellulose is provided from a solution; the mixture of the cellulose and nitrating agent and programmed deflagration of the resulting nitrocellulose is shown schematically in FIG. 7b. FIGS. 7c-7e illustrate embodiments in which the cellulose is supplied in the form of a gel (70b), a roll (70c), and a powder or grains (70d), respectively. FIG. 7f shows an additional embodiment in which the invention comprises at least one additional storage unit for storage of any additional component (e.g. a dye, an inhibitor, etc.) FIG. 7g and FIG. 7h illustrate embodiments (70f and 70g, respectively) in which the apparatus comprises multiple fuel storage containers and reaction chambers; embodiment 70g further comprises additional storage units for storage of any additional components required by the user. FIGS. 7i and 7j illustrate embodiments (70h and 70i, respectively) in which multiple reaction chambers are fed by a single set of fuel precursor storage containers; embodiment 70i further comprises additional storage units for storage of any additional components required by the user. It is acknowledged and emphasized that, as with the embodiments discussed above, the figures are provided for illustrative and exemplary purposes only, and are not to be construed in any sense as limiting the adaptation of the invention to use in a piston engine to any specific number, size, or geometry of reaction chambers, storage units, pistons, or any other component of the apparatus as adapted.

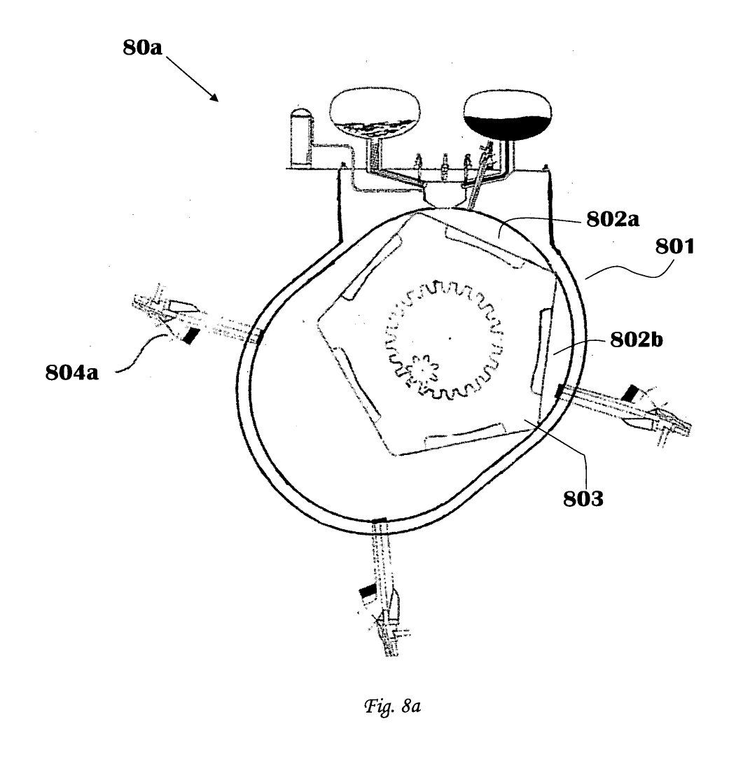

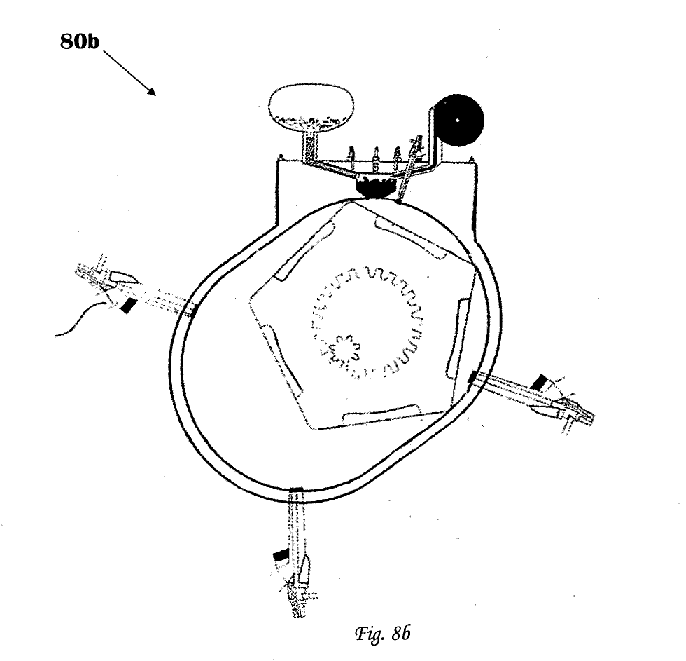

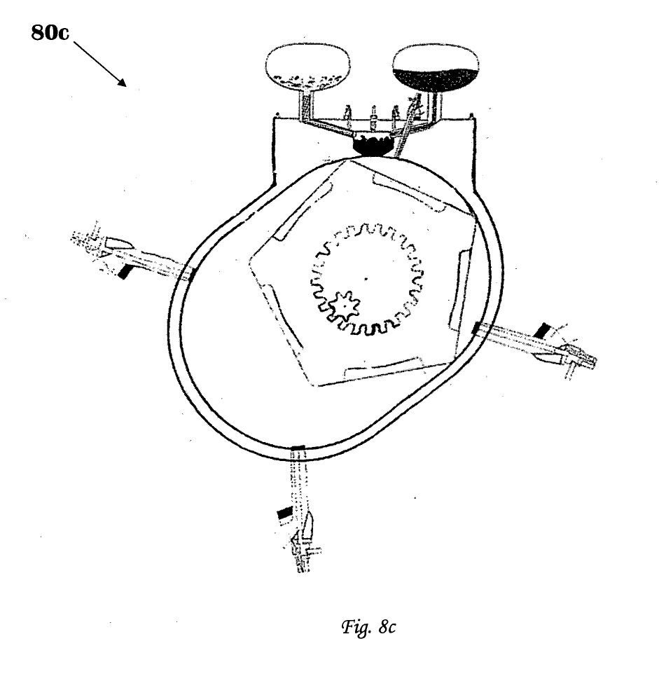

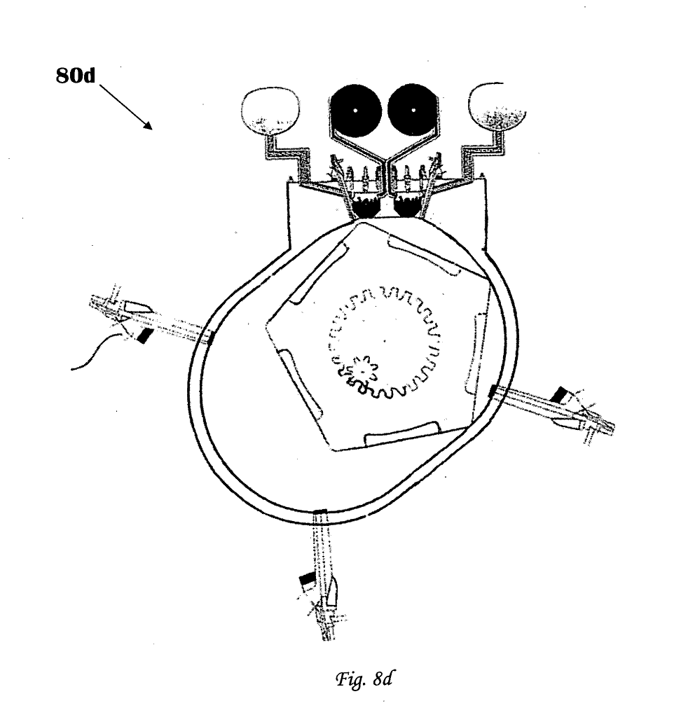

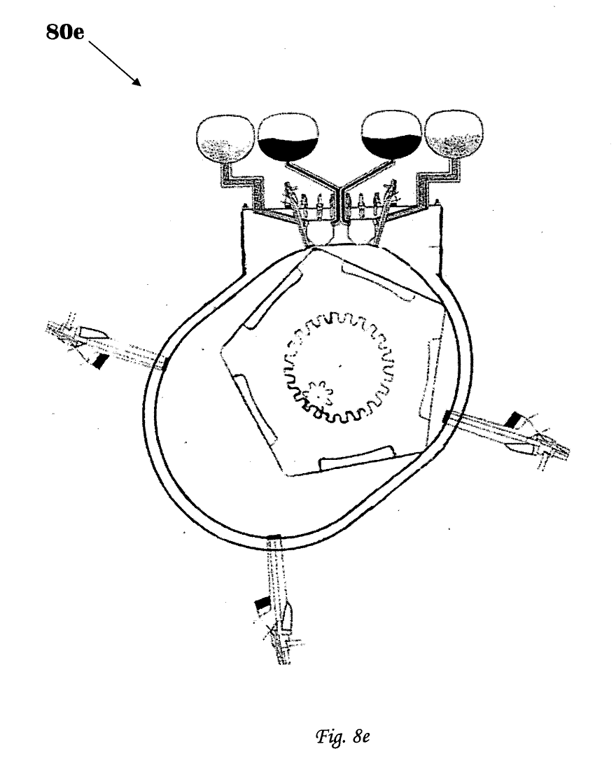

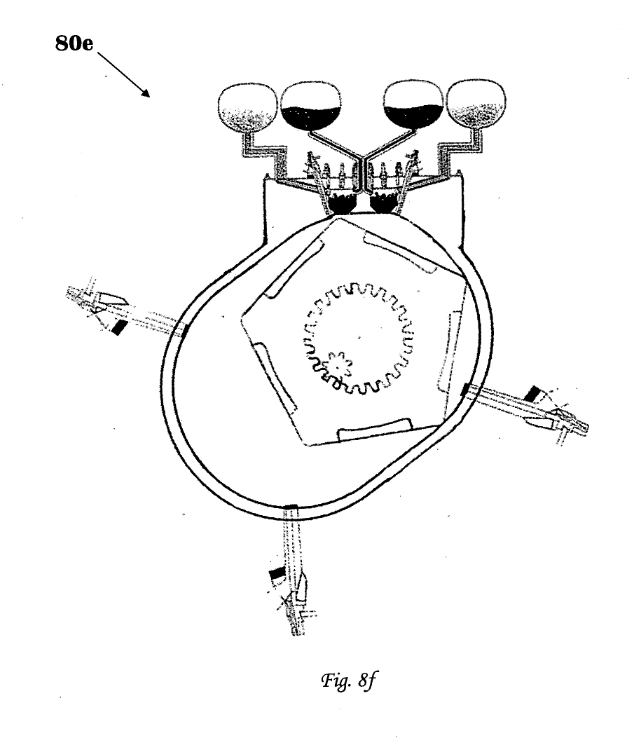

Reference is now made to the group of FIG. 8. These figures illustrate (not to scale) a family of embodiments in which the present invention is adapted for driving a rotary engine, e.g., the W. J. Ideal Rotary Engine™, which is described in detail in U.S. Provisional Pat. Appl. 60/935,522. FIG. 8a illustrates a typical embodiment (80a) of such an adaptation. The supply of fuel precursors and the reaction chamber are external to the engine 801. The products of the deflagration are discharged into one of a plurality of engine chambers 802a, 802b, etc., created by successive contacts between the central rotor 803 and the interior wall of the engine. The pressure of the gases entering the engine chamber causes the central rotor to rotate. The gases are carried into the next chamber and exhausted from one of a plurality of vents 804a, 804b, etc. For illustrative and exemplary purposes, only a single reaction chamber and associated apparatus is shown in FIG. 8; in practice, gases are fed independently into each of the engine chambers, as detailed in U.S. Provisional Pat. Appl. 60/935,522. In different embodiments of the invention, all of the engine chambers can be fed from a single fuel apparatus, or each chamber can be fed by a separate fuel apparatus. The timing of the exhaust of gases carried into a particular engine chamber by the rotation of the central rotor relative to the deflagration of the fuel that feeds the same chamber is determined by an external controller (e.g. a computer) according to a predetermined protocol. It is in the scope of the invention that the specific number of engine chambers (and likewise the number of vertices of the internal rotor) is not limited to the number shown in the figure, but can be any number of chambers appropriate to the particular application. FIG. 8a illustrates an embodiment in which the cellulose is provided from solution. Various additional embodiments are shown in FIGS. 8b-8e. FIG. 8b shows an embodiment 80b in which the cellulose is provided in the form of a roll, and FIG. 8c, an embodiment 80c in which the cellulose is provided in the form of a gel. In the embodiments illustrated in FIG. 8d, each engine chamber is fed by gases from two reaction chambers. FIG. 8d illustrates an embodiment 80d in which the cellulose is provided in the form of a roll; FIGS. 8e and 8f an additional embodiment 80e in which the cellulose is provided in the form of grains or flakes (FIG. 8f illustrates schematically the deflagration of the fuel). It is within the scope of the present invention that the fuel components can be provided in any form appropriate to in situ gas-phase formation of nitrocellulose, and not limited to those forms given for illustrative and exemplary purposes in the group of FIG. 8. It is further within the scope of the invention that the number of reaction chambers per engine chamber is not limited to those illustrated in the figures, but can be any number greater than or equal to one at the discretion of the operator.

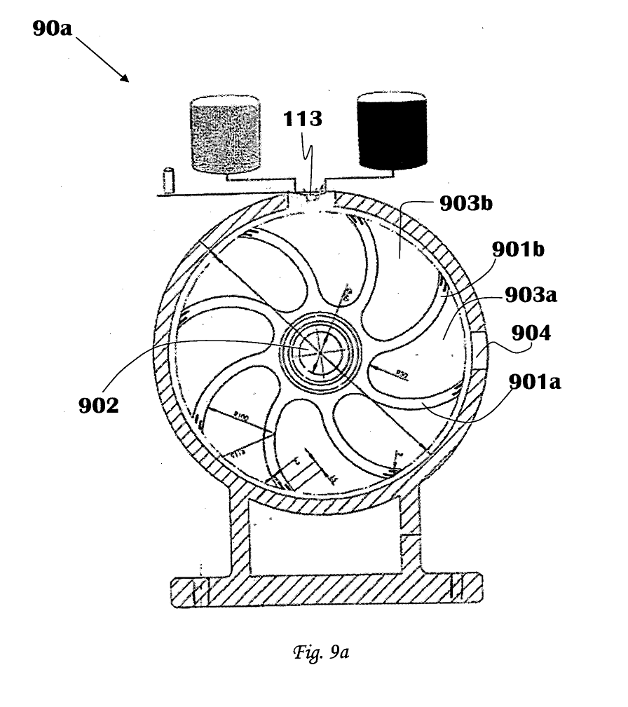

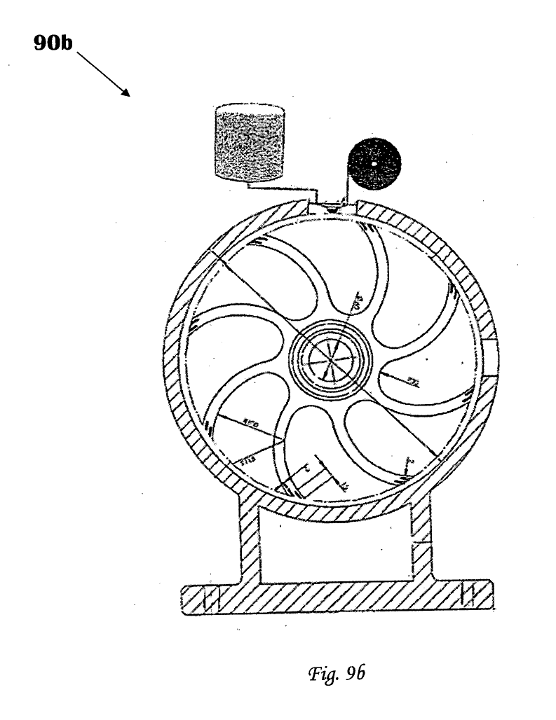

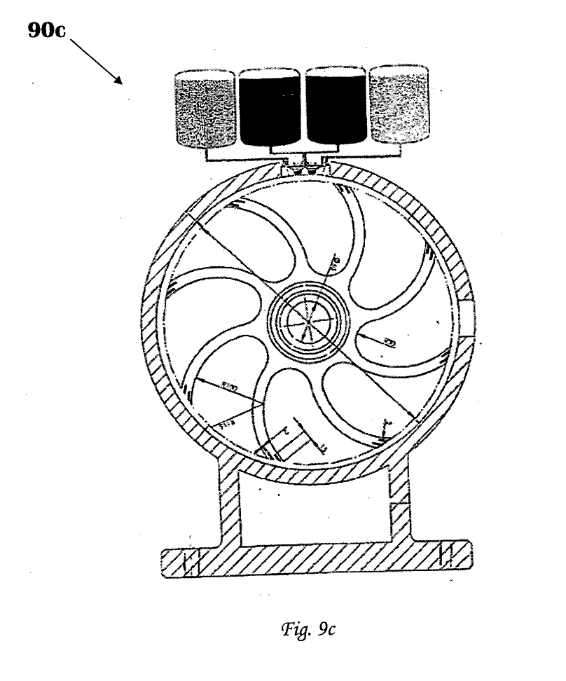

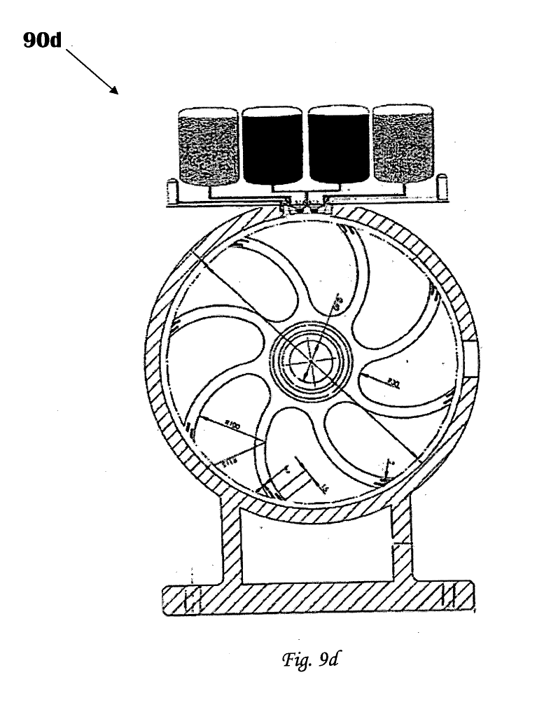

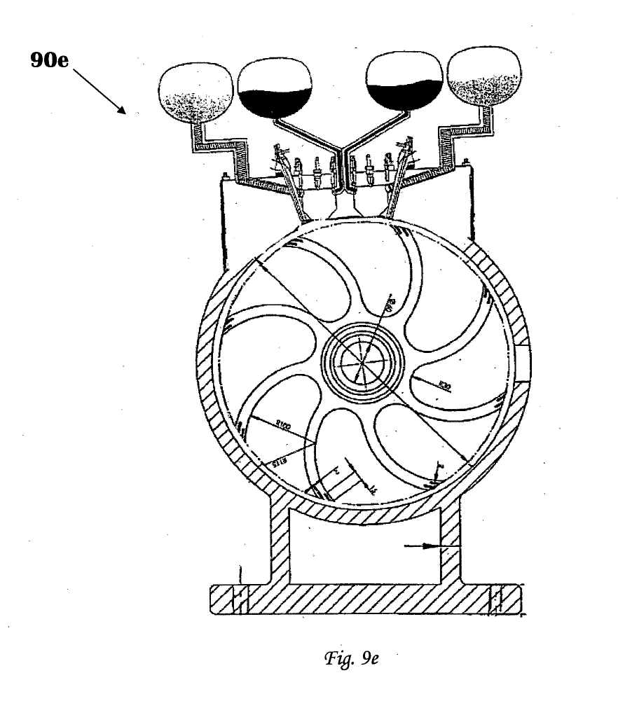

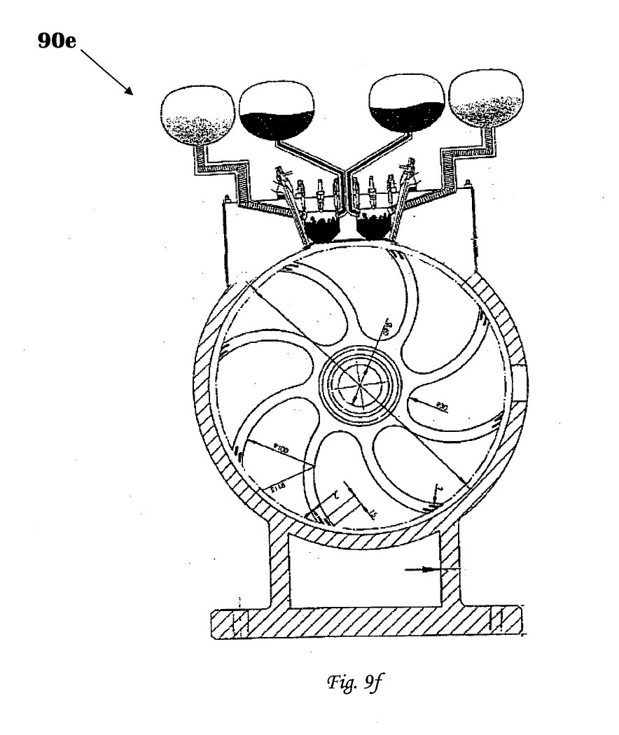

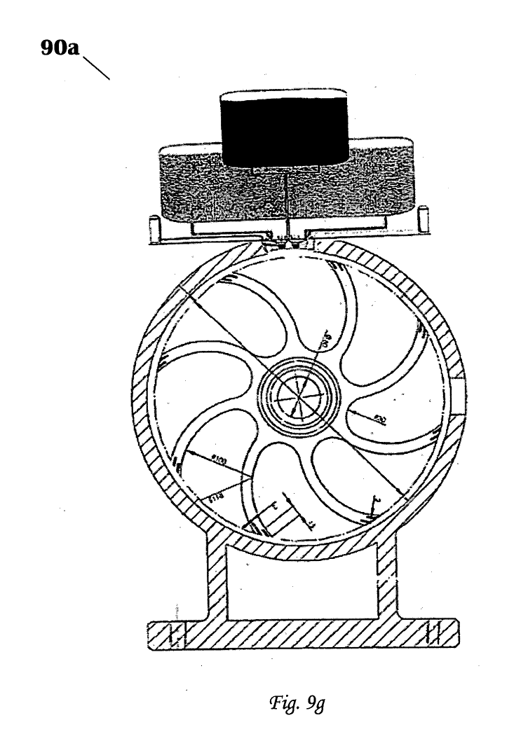

Reference is now made to the group of FIG. 9, illustrating (not to scale) an adaptation of the invention for driving a rotary vane engine (e.g. of the type disclosed in U.S. Pat. Appl. No. 61/043,749). In this engine design, a plurality of vanes (901a, 901b, etc.) extend from a central rotor 902, creating a plurality of engine chambers (903a, 903b, etc.), each one bounded by the contacts of two successive vanes with the interior wall of the engine. High-pressure gas is introduced into one of the engine chambers, causing rotation of the central rotor. The high-pressure gas is vented from the engine chamber when the rotation brings it to the exhaust port 904. FIG. 9a illustrates an embodiment (90a) in which the high-pressure gases are provided by predetermined deflagration of nitrocellulose created in the reaction chamber 113. In the embodiment illustrated, the cellulose is provided from solution, and an additional storage chamber is provided for any additional component (e.g. a stabilizer or inhibitor) desired. An additional embodiment 90b of the invention is illustrated in FIG. 9b. In this embodiment, the cellulose is provided in the form of a roll. FIG. 9c shows yet another additional embodiment (90c), in which the high-pressure gas is provided to an engine chamber by two independent reaction chambers. Each reaction chamber in this embodiment is supplied from its own independent set of fuel precursor containers. FIG. 9d shows an embodiment 90d additionally comprising containers for additional components (e.g. stabilizers or inhibitors) to be provided to the reaction chambers. FIGS. 9e and 9f illustrate an embodiment in which pressure relief valves are connected to the engine chamber into which the gaseous products of the deflagration are directed. These pressure relief valves are included as a safety measure to guard against overpressure within the engine itself. FIG. 9f illustrates the deflagration of the fuel within the reaction chambers. An additional embodiment 90f is illustrated in FIG. 9g. This embodiment also comprises two reaction chambers providing gas to the engine chamber, but in this case, a single set of fuel component containers supplies the nitrating agent and the cellulose to both reaction chambers. It is acknowledged and emphasized in this respect that the form(s) in which the fuel components are provided are not limited to those illustrated in the drawings, nor is any limitation on the number or form of any component of the engine (e.g., the number of reaction chambers, the number or shape of engine chambers and/or vanes) to be implied from the particular embodiments specifically illustrated.

It is within the scope of the invention to provide a method for in situ gas-phase formation of nitrocellulose, comprising the steps of (a) obtaining an apparatus as described above; (b) obtaining a nitrating agent; (c) introducing a predetermined quantity of said nitrating agent into said container for a nitrating agent; (d) obtaining cellulose; (e) introducing a predetermined quantity of said cellulose into said container for cellulose; (f) transferring a predetermined quantity of said cellulose from said container for cellulose to said reaction chamber; (g) transferring a predetermined quantity of said nitrating agent from said container for a nitrating agent to said reaction chamber; (h) applying a predetermined voltage to said heating plug and/or spark plug for a predetermined period of time; (i) waiting a predetermined time; (j) repeating steps (f) through (i). Unlike previous methods for formation of nitrocellulose from cellulose and an appropriate nitrating agent, in which the reaction takes place over hours, in the present invention, nitrocellulose is formed in seconds or less, which makes the method an attractive one for in situ formation of nitrocellulose to be used as a fuel or as a propellant. A schematic presentation of the method herein disclosed is given in FIG. 10a.

It is within the scope of the invention to provide a method for in situ gas-phase formation and deflagration and/or combustion of nitrocellulose, in which the method described for the formation of nitrocellulose comprises the additional step of deflagration and/or combustion of the nitrocellulose in the same reaction chamber. Indeed, under most circumstances of use, the nitrocellulose will deflagrate spontaneously no more than seconds after its formation without any need for an additional independent ignition step. A typical sequence of events according to one specific embodiment of this method is given schematically in FIG. 10b.

The nitrating agent used in the method disclosed in the present invention is chosen from the group consisting of (a) highly concentrated nitric acid; (b) concentrated nitric acid; (c) dilute nitric acid; (d) NO₂; (e) a mixture of NO₂ and H₂O; (f) any other substance capable of nitrating cellulose in the gas phase; (g) any combination of the above.

The form of cellulose used in the method disclosed in the present invention is chosen from the group consisting of (a) solution; (b) suspension; (c) gel; (d) granules; (e) flakes; (f) grains; (g) pellets; (h) fibers; (i) roll; (j) straw; (k) paper; (l) any other form capable of undergoing gas-phase nitration; (m) any combination of the above. According to a preferred embodiment of the invention, the cellulose must enter the chamber in the form of particles of size of about 0.1-0.3 mm³; the small size of the particle ensures efficient formation of nitrocellulose and efficient deflagration. Thus, according to this preferred embodiment, if the cellulose is not already provided in a form of small particles (e.g. grains, flakes, pellets, etc.), the system for introducing the cellulose into the reaction chamber will additionally include means for reducing the cellulose from its form in the CC to the optimal size, e.g. by use of a shredder, chopper, etc., placed within the system for delivering cellulose from the CC to the reaction chamber.

It is in the scope of the present invention that the order and timing of the steps of the method may be under the control of an external controller (e.g. a computer) according to a predetermined protocol. Such an external controller will, in some embodiments of the method, also serve as a fail-safe for the apparatus. For example, an external controller can ensure that no nitrating agent enters the reaction chamber if there is not already cellulose within it, thus preventing damage to the apparatus from unreacted nitrating agent.

An additional embodiment of the method disclosed in the present invention comprises the additional step of introducing at least one additional material into the reaction chamber from an independent storage unit.

### EXAMPLES

The invention will now be explained in further detail with reference to the following examples and comparative examples.

In order to demonstrate the utility of the present invention, a series of experiments were run involving formation and deflagration of a measured quantity of nitrocellulose according to the present invention; under the reaction conditions, approximately 13% nitration of the cellulose was achieved. The cellulose was introduced into the chamber in the form of flakes about 1.5×1.5×0.6 mm in size. The expansion of gases from the deflagration was used to drive a piston weighing 860 kg, and the pressure behind the piston, distance traveled by the piston, and velocity of the piston were measured as a function of time following initiation of deflagration. The results of the experiments (examples 1-3) demonstrate that even small amounts of fuel introduced into the present invention produce sufficient impulse to drive an engine or other device in a manner that is both useful and practical.

### Example 1

Results for a typical set of reaction conditions are shown in FIG. 11. FIG. 11a shows the pressure behind the piston as a function of time. As can be seen, the pressure reaches 30 Bar within 20 ms of the introduction of the fuel components into the reaction chamber, which is sufficiently rapid to run such a piston repeatedly at a rate of several hundred Hz, i.e., at a rate typical for conventionally-fueled reciprocating piston engines. FIG. 11b shows the distance traveled by the piston as a function of time following the commencement of deflagration. As can be seen from the figure, even the small amount of fuel present in the reaction chamber (about 20 g) was sufficient to move the piston 1 m in less than 0.1 s, demonstrating that even a small amount of fuel is sufficient to move a large piston through a distance typical of its motion in an engine. FIG. 11c shows the piston's velocity as a function of time following the commencement of deflagration. As can be seen in the figure, it achieves 50% of its final velocity within 40 ms, and 90% of its final velocity within 80 ms.

### Example 2

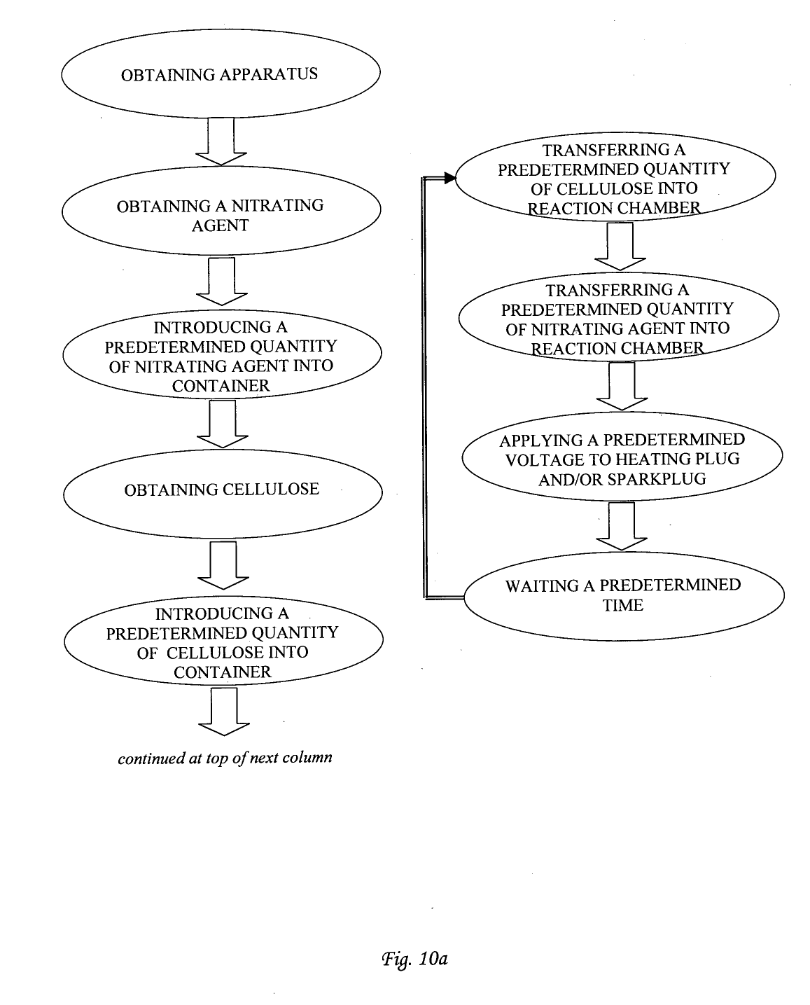

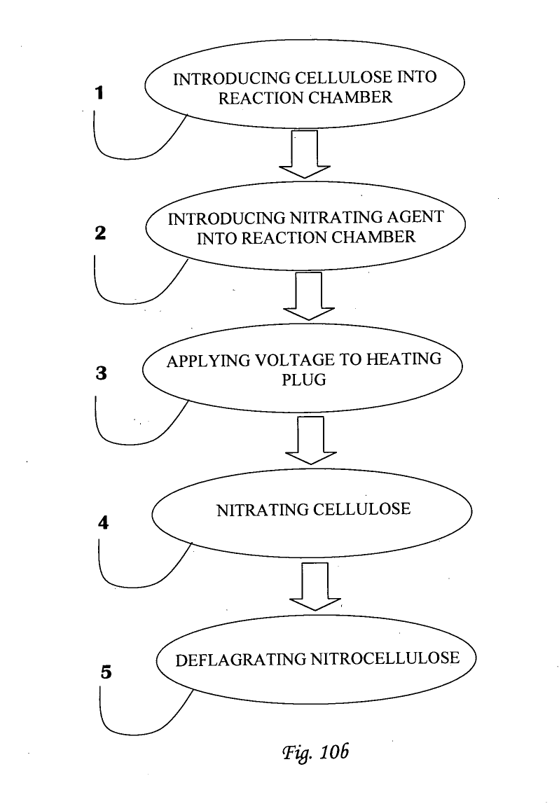

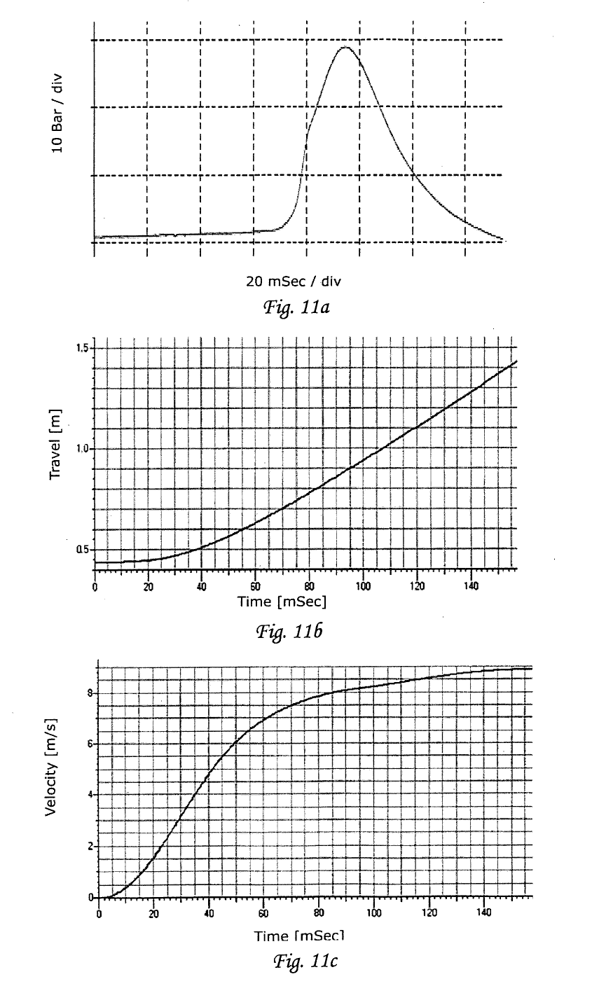

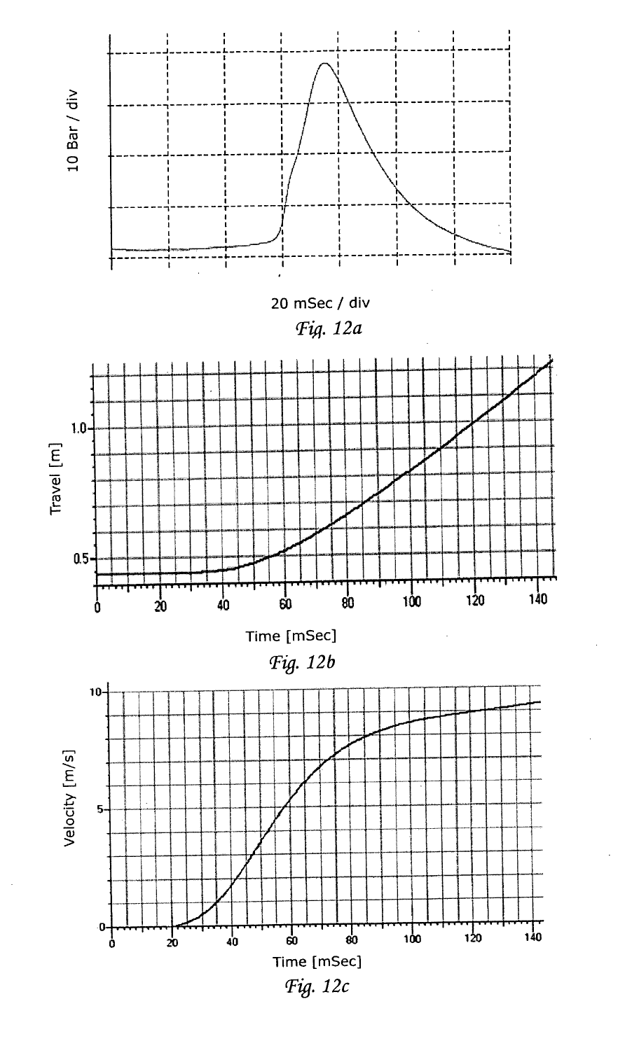

A second experiment was performed with the same piston and amount of fuel, but with a smaller confinement volume for the reaction chamber. FIG. 12a shows the pressure behind the piston as a function of time following the commencement of deflagration. Not surprisingly, reducing the effective volume of the reaction chamber increases the pressure behind the piston. Again, the peak pressure is reached within 20 ms of the initiation of the deflagration. As shown in FIGS. 12b and 12c, which show the piston travel and velocity as a function of time, the piston travels 1 m in about 0.1 s, and reaches about 90% of its final velocity within 80 ms.

### Example 3

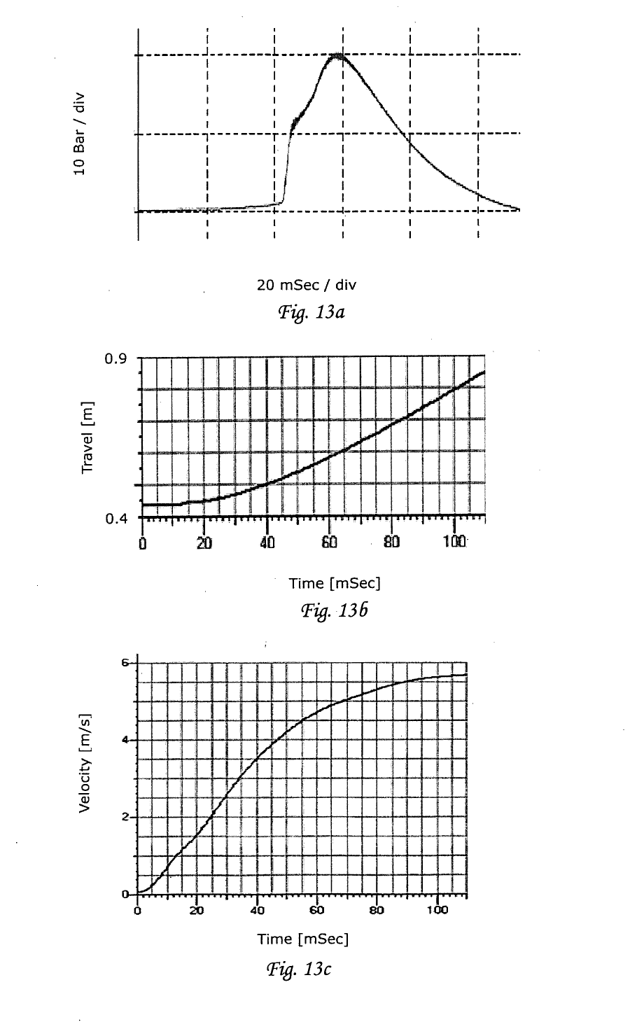

A third experiment was performed in which the amount of fuel was halved from that of the experiment described in Example 2. FIG. 13a shows the pressure behind the piston as a function of time following initiation of deflagration of the fuel. FIG. 13b shows that the maximum pressure is reached in less than 20 ms and is about ⅔ of that achieved with 20g of fuel in the reaction chamber. In the first 0.1 s following the onset of deflagration of the fuel, the piston traverses about 80% of the distance and achieves about 70% of the final velocity as it had in the previous experiment, as shown in FIG. 13c.

### Example 4

A calculation was performed of the deflagration of nitrocellulose under conditions similar to those found in the present invention. For 13.15% nitrated nitrocellulose, the calculations predict that the deflagration temperature will be 3045° C., and the product distribution of the gases following deflagration will be 14.3% CO₂; 40.5% CO; 9.2% H₂; 11.9% N₂; and 24.1% H₂O.

1-23. (canceled)

24. A reaction chamber for in situ gas-phase preparation of and deflagration of a fuel, preferably nitrocellulose, comprising:
a. means for independently introducing a plurality of precursors into and combining said precursors within said reaction chamber;
b. means for deflagrating said fuel;
wherein said preparation and deflagration of said fuel occur on a time scale measured in about tens of milliseconds.

25. An engine characterized by at least one reaction chamber of claim 1 and at least one actuator such that discharge of gases produced by deflagration of said fuel actuates said actuator.

26. An apparatus for in situ gas-phase preparation and deflagration of nitrocellulose, comprising:
a. at least one nitrating agent container (NAC);
b. at least one cellulose container (CC);
c. at least one reaction chamber of claim 1, each of said at least one reaction chamber interconnected with at least one of said at least one NAC further interconnected independently with at least one of said at least one CC, said reaction chamber further being characterized by:
i. resistance to attack by said nitrating agent;
ii. adapted for use at effective pressure for in situ production and deflagration of nitrocellulose;
iii. leak-proof;
iv. having at least one plug selected from the group consisting of: heating plug; spark plug, said plug passing through an external wall of said reaction chamber;
v. an inlet for cellulose, said inlet passing through an external wall of said reaction chamber and interconnected to said outlet of said cellulose container;
vi. an inlet for a nitrating agent, said inlet passing through an external wall of said reaction chamber;
vii. a nozzle, interconnected with said inlet for a nitrating agent, said nozzle adapted to convert a flow of a fluid to a spray; and,
viii. means for discharging gases formed in a chemical reaction occurring within said reaction chamber;
wherein said apparatus is adapted for: in situ formation of nitrocellulose in the gas phase on a time scale measured in tens of milliseconds; in situ deflagration of said nitrocellulose occurring within tens of milliseconds of its formation; and, directional discharge of high-pressure gases formed during said deflagration.

27. The apparatus of claim 26, in which said at least one plug is adapted to heat said reaction chamber to a temperature from about 230° C. to about 300° C.

28. The apparatus of claim 26, further comprising means for maintaining said CC under an inert atmosphere.

29. The apparatus of claim 26, in which said NAC and said CC have characteristics chosen from the group consisting of:
a. isolates the fuel from at least one of heat, static electricity, sparks, lightning, fire, shock, water, shock waves;
b. fully armor protected against light firearms and RPGs;
c. provided with self-cooling and dry-air systems adapted to keep said stored anaerobic fuel at a temperature of not more than about 35° C. and not less than about −20° C.;
d. storable in vacuum conditions; and further wherein said storage unit is characterized by a container-within-a-container arrangement.

30. The apparatus of claim 26, in which said reaction chamber is further characterized by a pressure relief valve.

31. The apparatus of claim 26, in which said means for delivering a predetermined amount of nitrating agent from said container to a predetermined location external to said nitrating agent container comprises:
a. a valve, said valve adapted to control flow of the contents of said container from said container to said predetermined location external to said container; and,
b. means for pumping at a predetermined rate the contents of said container from said container to said predetermined location external to said container.

32. The apparatus of claim 26, in which said means for delivering a predetermined amount of cellulose from said cellulose container to a predetermined location external to said container are characterized by
a. a valve, said valve adapted to enable and/or to prevent flow of the contents of said container from said container to said predetermined location external to said container; and,
b. means for pumping at a predetermined rate the contents of said container from said container to said predetermined location external to said chamber.

33. The apparatus of claim 26, further comprising
a. a container adapted for accommodating a third material, said container fluidly connected to said reaction chamber;
b. means for delivering the contents of said container to said reaction chamber.

34. The apparatus of claim 26, further comprising a controller adapted to control at least one of the components of the apparatus according to a predetermined protocol.

35. The apparatus of claim 24, adapted to drive a device selected from the group consisting of: turbine, piston engine, gas turbine, rotary engine, rotary vane engine.

36. A method for in situ gas-phase formation of nitrocellulose, comprising the steps of:
a. obtaining an apparatus as described in claim';
b. obtaining a nitrating agent;
c. introducing a predetermined quantity of said nitrating agent into said container for a nitrating agent;
d. obtaining cellulose;
e. introducing a predetermined quantity of said cellulose into said container for cellulose;
f. transferring a predetermined quantity of said cellulose from said container for cellulose to said reaction chamber;
g. transferring a predetermined quantity of said nitrating agent from said container for a nitrating agent to said reaction chamber;
h. applying a predetermined voltage to said plug for a predetermined period of time;
i. waiting a predetermined time;
j. repeating steps (f) through (i);
wherein heat provided by said plug initiates reaction between said nitrating agent and said cellulose, and further wherein said reaction between said nitrating agent and said cellulose yields rapid in situ gas-phase formation of nitrocellulose.

37. The method of claim 36, in which formation of nitrocellulose is followed by rapid deflagration of said nitrocellulose.

38. The method of claim 36, in which formation of nitrocellulose is followed by rapid combustion of said nitrocellulose.

39. The method of claim 36, in which said nitrating agent is chosen from the group consisting of: highly concentrated nitric acid; concentrated nitric acid; dilute nitric acid; NO₂; a mixture of NO₂ and H₂O; a substance capable of nitrating cellulose in the gas phase; and combinations thereof.

40. The method of claim 36, in which the form of said cellulose is chosen from the group consisting of: solution; suspension; gel; granules; flakes; grains; pellets; fibers; roll; straw; paper; any other form capable of undergoing gas-phase nitration; combinations thereof.

41. The method of claim 36, comprising the further step of controlling steps (f) through (i) by a controller according to a predetermined protocol.

42. The method of claim 36, comprising the further step of introducing at least one additional material into the reaction chamber from an independent storage unit.
